(19) United States
(12) Patent Application Publication
(10) Pub. No.: US 2025/0106742 A1
(43) Pub. Date: Mar. 27, 2025

(54) PERSONAL INTERNET-OF-THINGS NETWORKS

(71) Applicant: Apple Inc., Cupertino, CA (US)

(72) Inventors: Sudeep Manithara Vamanan, Uttenreuth (DE); Babar Qaisrani, Issaquah, WA (US); Biljana Badic, Munich (DE); Haijing Hu, Los Gatos, CA (US); Krisztian Kiss, Rancho Santa Fe, CA (US); Robert Zaus, Munich (DE)

(21) Appl. No.: 18/832,642

(22) PCT Filed: Jan. 27, 2023
(86) PCT No.: PCT/US2023/011736

§ 371 Date: Jul. 24, 2024

Related U.S. Application Data
(60) Provisional application No. 63/304,487, filed on Jan. 28, 2022.

(51) Int. Cl. H04W 48/16; H04W 40/24; H04W 76/10

(52) U.S. Cl. CPC H04W 48/16; H04W 40/246; H04W 76/10

(57) ABSTRACT

Disclosed are methods, systems, and computer-readable medium to perform operations including: generating a registration request comprising a capability of the UE to serve as a gateway for a personal Internet-of-things network (PIN); sending the registration request to a base station serving the UE; receiving, from the base station, a registration accept message comprising a PIN gateway authorization; and initiating establishment of the PIN with at least one other device, wherein the UE serves as the gateway of the PIN to the base station.

### CROSS-REFERENCE TO RELATED APPLICATIONS

The present application claims priority to U.S. Prov. App. No. 63/304,487, filed on Jan. 28, 2022, entitled “PERSONAL INTERNET-OF-THINGS NETWORKS,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

One of the features being developed by the 3rd Generation Partnership Project (3GPP) is a personal Internet-of-things (IoT) network (PIN). A PIN can be operated in co-operation with a home public land mobile network (PLMN) provided by a mobile network operator (MNO). However, PINs remain under development and there are currently many unaddressed challenges facing PIN adoption.

Disclosed herein are solutions that address many of the open challenges facing PIN adoption. Among other things, this disclosure describes PIN attributes, architectural aspects of PINs, configurations for PEGC/PEMC authorization, configurations for PIN operation in connection with an associated network, identifiers for PIN establishment and policy parameters, procedures for notification and parameter provisioning, PIN establishment with pre-provisioned policies or with dynamic policies, and UE initiated dynamic PIN establishment. This disclosure also describes methods and systems for implementing the disclosed solutions.

In accordance with one aspect of the present disclosure, a method to be performed by a user equipment (UE) is disclosed. The method involves generating a registration request including a capability of the UE to serve as a gateway for a personal Internet-of-things network (PIN); sending the registration request to a base station serving the UE; receiving, from the base station, a registration accept message including a PIN gateway authorization; and initiating establishment of the PIN with at least one other device, where the UE serves as the gateway of the PIN to the base station.

Other versions include corresponding systems, apparatus, and computer programs to perform the actions of methods defined by instructions encoded on computer readable storage devices. These and other versions may optionally include one or more of the following features.

In some implementations, the registration request further includes one or more PIN attributes.

In some implementations, the one or more PIN attributes include at least one of: a PIN class, a PIN traffic scope providing a location of PIN traffic, a PIN traffic class, or a PIN size.

In some implementations, the method further including: receiving, from the base station, a UE policy container including at least one of: a PIN identifier, an indication whether to report the establishment of the PIN to the base station, or one or more sets of UE route selection policy (URSP) rules for PIN traffic.

In some implementations, each of the one or more sets is associated with a respective set of PIN attributes.

In some implementations, the method further including: transmitting a PIN establishment request to the base station; receiving a PIN establishment accept message from the base station; and responsively completing the establishment of the PIN.

In some implementations, the PIN establishment request includes at least one of a PIN identifier or an identifier of the UE, and the PIN establishment accept message includes at least one of a PIN duration or a location restriction.

In some implementations, the method further including: receiving application traffic from the at least one other device; determining UE route selection policy (URSP) rules for the application traffic; and based on the URSP rules, initiating establishment of a Protocol Data Unit (PDU) session to route the application traffic.

In some implementations, the method further including: transmitting a UE policy provisioning request to the base station; and receiving a UE policy command from the base station, where the UE policy command includes at least one of: a PIN identifier, an indication whether to report the establishment of the PIN to the base station, or UE route selection policy (URSP) rules for PIN traffic.

In some implementations, transmitting the UE policy provisioning request is performed in response to determining that the UE does not have valid policies for the PIN.

In some implementations, the method further including: transmitting, via application layer signaling, one or more PIN attributes to a PIN application function (AF); and receiving, from the base station, a UE policy container including at least one of: a PIN identifier, an indication whether to report the establishment of the PIN to the base station, or UE route selection policy (URSP) rules for PIN traffic, where the URSP rules are based on the one or more PIN attributes. The URSP rules may further include Route Selection Validation Criteria, which restrict the establishment of the PDU session related to PIN to a specific location and time.

In some implementations, the method further including: receiving application traffic from the at least one other device; determining UE route selection policy (URSP) rules for PIN traffic; and based on the URSP rules, determining to establish a new Protocol Data Unit (PDU) session with specified PIN configurations, the specified PIN configurations including a dedicated Data Network Name (DNN) and a serving network slice selection assistant information (S-NSSAI); and transmitting a PDU session establishment request to the base station.

In accordance with another aspect of the present disclosure, a method includes: receiving, from a user equipment (UE), a registration request including a capability of the UE to serve as a gateway for a personal Internet-of-things network (PIN); determining, based on a subscription data for the UE, that the UE is authorized to serve as the gateway for the PIN; and transmitting, to the UE, a registration accept message including a PIN gateway authorization.

Other versions include corresponding systems, apparatus, and computer programs to perform the actions of methods defined by instructions encoded on computer readable storage devices. These and other versions may optionally include one or more of the following features.

In some implementations, the method further including: determining, based on the subscription data for the UE, one or more PIN policies for the PIN; and transmitting the one or more PIN policies to the UE.

In some implementations, the one or more PIN policies include at least one of: a PIN identifier, an indication whether to report the establishment of the PIN to the base station, or UE route selection policy (URSP) rules for PIN traffic.

In some implementations, the one or more PIN policies are received from a PIN application function (AF).

In some implementations, the one or more PIN policies are default PIN policies.

In some implementations, the method further including: receiving a PIN establishment request from the UE, the PIN establishment request including at least one of: a PIN identifier, a UE identifier, or one or more PIN attributes; provisioning, based on the subscription data for the UE, one or more restrictions for the PIN; and communicating a PIN establishment accept message to the UE, the PIN establishment accept message including the one or more restrictions for the PIN.

In some implementations, the method further including: in response to receiving the PIN establishment request, triggering an event exposure notification to a PIN application function (AF), the event exposure notification including the one or more PIN attributes; receiving one or more PIN policies from the PIN AF; determining, based on the one or more policies, a PIN policy update to provide to the UE; and communicating the PIN policy update to the UE.

In some implementations, the method further including: receiving, from the UE, a request to establish a new Protocol Data Unit (PDU) session, the request including a dedicated Data Network Name (DNN) and a serving network slice selection assistant information (S-NSSAI); determining, based on one or more session management (SM) policies, that the UE is allowed to establish the new PDU session at a current time and a current UE location; and communicating with a PIN application function (AF) to perform secondary authentication and authorization of the request to establish the new PDU session, where the PIN AF serves as a Data Network (DN)-authentication, authorization, accounting (AAA) entity.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example system that includes personal Internet-of-things (IoT) networks (PINs), according to some embodiments.

FIG. 2 illustrates a common interface for PIN elements, according to some embodiments.

FIG. 3 illustrates a block diagram that shows the handling of PIN policies, according to some embodiments.

FIG. 4A illustrates a call flow for PIN parameter provisioning, according to some embodiments.

FIG. 4B illustrates a call flow for PIN parameter notification, according to some embodiments.

FIG. 5A illustrates a call flow for PIN establishment with pre-provisioning of PIN policies, according to some embodiments.

FIG. 5B illustrates an alternate call flow for PIN establishment with pre-provisioning of PIN policies, according to some embodiments.

FIG. 6 illustrates a call flow for user plane based authorization for PIN establishment, according to some embodiments.

FIG. 7 illustrates a call flow for PIN establishment with dynamic policy updates, according to some embodiments.

FIG. 8A illustrates a call flow for UE-initiated creation of a new PIN, according to some embodiments.

FIG. 8B illustrates a call flow for UE-initiated creation of a new PIN with the involvement of a PIN AF, according to some embodiments.

FIG. 9A illustrates a flowchart of an example method, according to some embodiments.

FIG. 9B illustrates a flowchart of another example method, according to some embodiments.

FIG. 10 illustrates a user equipment (UE), according to some embodiments.

FIG. 11 illustrates an access node, according to some embodiments.

FIG. 12 illustrates an architecture of a system including a core network (CN), according to some embodiments.

### DETAILED DESCRIPTION

One of the features being developed by the 3rd Generation Partnership Project (3GPP) is a personal Internet-of-things (IoT) network (PIN). A PIN can be operated in co-operation with a home public land mobile network (PLMN) provided by a mobile network operator (MNO). As an example, a PIN can be operated in co-operation with a 3GPP 5th Generation System (5GS). A PIN can include, among other things, cellular user equipment (UE) and IoT devices. Among many examples, IoT devices include machine-type communication (MTC) devices, vehicle-to-everything (V2X) devices, and wearable devices. A device that part of a PIN is referred to as an “element” of that PIN.

One of the elements in a PIN has an active management capability (PEMC) and the same or another element has an active gateway capability (PEGC). A PEMC is responsible for managing a PIN, and a PEGC is responsible for routing communications between the PIN and external systems (e g., a 5GS or a cloud server). Generally, a PIN element can be any wireless device and is not restricted to being a 3GPP-based wireless device. However, a PIN element that serves as a PEMC, a PEGC, or both is a 3GPP-based wireless device (or a 3GPP compatible device) so that the element can communicate with a network associated with the PIN.

Some of the PIN features provisioned by 3GPP include that a PIN element can be authenticated without using 3GPP credentials, a PIN element can be a member of different PINs, a PIN element is not required to be a subscriber to the same MNO as the PIN element(s) serving as PEGC/PEMC, and communication between the elements could be using non-3GPP methods (e.g., Bluetooth®, Wi-Fi, WLAN, etc.) or 3GPP methods (e.g., ProSe PC5 Sidelink). However, PINs remain under development and there are currently many unaddressed challenges facing PIN adoption. One challenge is the lack of interoperability between the elements of a PIN. This challenge is due to different types of devices using different connectivity protocols. Another issue is how to enhance user equipment (UE) capabilities with gateway and management capabilities (e.g., PEGC, PEMC). Yet another challenge is user privacy. Specifically, there are no existing techniques to deliver only necessary information to the associated network while preserving user privacy.

Disclosed herein are solutions that address many of the open challenges facing PIN adoption. Among other things, this disclosure describes PIN attributes, architectural aspects of PINs, configurations for PEGC/PEMC authorization, configurations for PIN operation in connection with an associated network, identifiers for PIN establishment and policy parameters, procedures for notification and parameter provisioning, PIN establishment with pre-provisioned policies or with dynamic policies, and UE initiated dynamic PIN establishment. This disclosure also describes methods and systems for implementing the disclosed solutions.

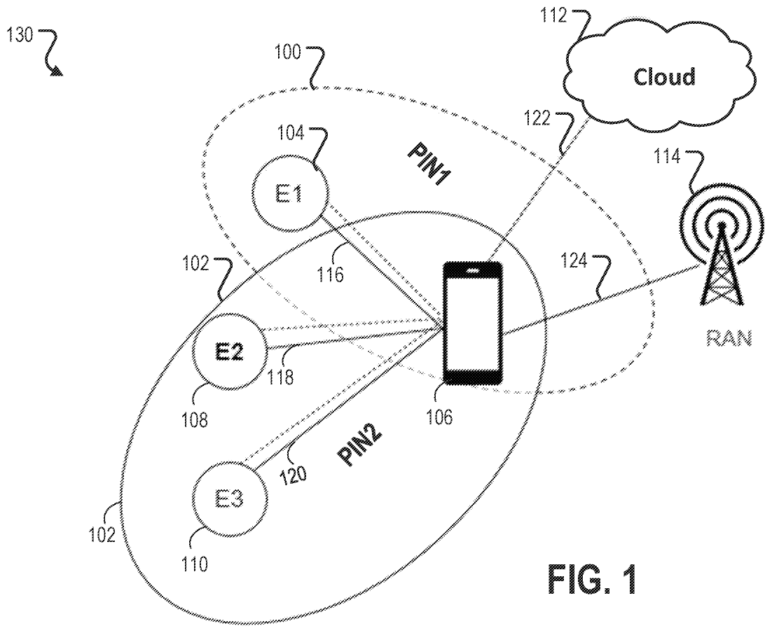

FIG. 1 illustrates an example system 130 that includes personal Internet-of-things (IoT) networks (PINs) 100 and 102, according to some embodiments. PINs 100, 102 are operated in co-operation with an associated wireless communication system. For purposes of convenience and without limitation, the system 130 is described in the context of Fifth Generation (5G) New Radio (NR) communication standards as defined by the 3GPP technical specifications. For example, the wireless communication system associated with PINs 100, 102 may be a 5GS. However, other types of communication systems are possible, including legacy 3GPP systems, e.g., Long Term Evolution (LTE) systems, and future 3GPP systems (e.g., Sixth Generation [6G]) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In some embodiments, PINs 100, 102 may be smart home networks, networks of wearable devices, or other types of networks. As shown in FIG. 1, PIN 100 (also labeled as “PIN1”) and PIN 102 (also labeled as “PIN2”) include a plurality of elements. In some embodiments, a device can be an element of more than one PIN. In the example of FIG. 1, UE 106 is an element of both PINs 100, 102. PIN 100 also includes element 104 (also labeled as “E1”), and PIN 102 also includes element 108 (also labeled as “E2”) and element 110 (also labeled as “E3”). In the system 130, UE 106 is a 3GPP-based device and elements 104, 108, 110 may be 3GPP-based devices or non-3GPP-based devices. Furthermore, UE 106 is configured as both PEGC and PEMC of PINs 100, 102. As such, UE 106 serves as a gateway between PINs 100, 102 and external systems. In FIG. 1, UE 106 serves as a gateway between PINs 100, 102 and the associated 5GS by way of radio access network (RAN) 114. UE 106 can also serve as a gateway to other external systems, such as cloud 112. As shown in FIG. 1, UE 106 uses links 116, 118, 120, 122, 124 to communicate with E1, E2, E3, cloud 112, and RAN 114, respectively. Note that the links 116, 118, and 120 are represented using two lines to represent the connections to the RAN and the cloud, but each of the links may be a single connection with the UE 106.

In an example, PINs 100, 102 can be created by a user, e.g., using a PEMC UE. In another example, PINs 100, 102 can be created by an application function (AF) dedicated to PINs (also referred to as a “PIN AF”). In yet another example, PINs 100, 102 can be created by the 5GS associated with the PINs. As described in more detail below, the 5GS can also manage provisioning of PIN policies, authentication of elements, and onboarding of elements for PINs 100, 102.

In some embodiments, PINs 100, 102 are each assigned one or more attributes, e.g., upon creation of the PIN. A PIN attribute is indicative of an operating characteristic of the corresponding PIN. The attributes, which can be provided to the 5GS, enable the MNO to better serve the PIN, for instance, by customizing the service provided to the PIN based on the PIN's attributes. As an example, the MNO can define and assign policies for a PIN based on that PIN's attributes. More specifically, the MNO may allow only certain type of PINs to operate in co-operation with the 5GS, the MNO may provide different services to different types of PINs, and/or the MNO may assign different priorities to different types of PINS.

In some embodiments, the PIN attributes include a PIN class (e.g., an indication of the type of devices in the PIN), a PIN traffic scope (e.g., an indication of the location of the PIN's traffic), a PIN traffic class (e.g., priority of the PIN traffic), and a PIN size (e.g., an indication of a size of the PIN). The categories within the PIN class include a private PIN (e.g., home network), a public PIN (e.g., shopping mall), and a personal body area PIN (e.g., smart watch, smart glasses). The categories within the PIN traffic scope include: (i) local (e g., traffic flow is preserved within the PIN), (ii) partially local (e.g., some elements send traffic to the associated 5GS), and (iii) cloud (e.g., PIN elements communicate with a cloud server). The categories within the PIN traffic class include high priority traffic and low priority traffic. The PIN size is a size of the PIN to be shared with the network. The size of PIN can be defined in different ways, e.g., number of elements (an exact number or a range), an aggregated load of the PIN, duty cycle of the elements of the PIN, among other examples. Other PIN attributes and categories within PIN attributes are possible and contemplated herein.

In some embodiments, the elements of a PIN are configured with a PIN layer that serves as a common interface for exchanging information between the PIN elements. Specifically, the PIN layer can be used to exchange information between PINs that may have different communication protocols. Thus, the PIN layer enables the devices to seamlessly communicate within the PIN. For example, the PIN layer output can be provided to the PEGC/PEMC device(s), which, as stated previously, are 3GPP compatible and can communicate with the associated 5GS. As another example, the PIN layer could also be used as a communication layer between PIN elements and the 3GPP network.

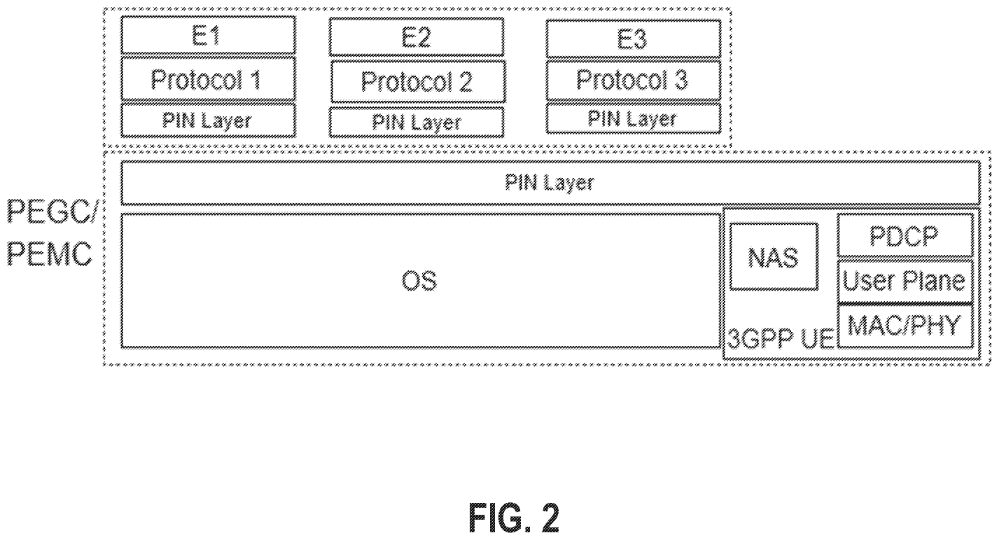

FIG. 2 illustrates a common interface for PIN elements, according to some embodiments. In an example, E1, E2, E3, and UE are similar to E1, E2, E3, and UE 106, respectively, of FIG. 1. As shown in FIG. 2, each PIN element includes a respective PIN layer in addition to the respective PIN element's protocol. For example, in addition to Protocol 1, E1 also includes a respective PIN layer. The respective PIN layers interface with the respective protocol layers and with each other.

In some embodiments, the 5GS associated with a PIN performs authorization and policy provisioning processes for the PINs. As described in more detail below, the authorization and policy provisioning processes can be initiated by a UE that is serving as PEGC. The authorization and policy provisioning processes may use that UE's subscription data. In some examples, a UE's subscription data includes (i) an authorization to act as a PEGC and/or a PEMC, and/or (ii) information indicating whether the UE is allowed to dynamically request creation of a new PIN. The authorization to act as PEGC and/or PEMC may be an open authorization (e.g., a UE has authorization to act as PEGC and/or PEMC for any PIN) or may be a restricted authorization (e.g., a UE has authorization to act as PEGC and/or PEMC for specific PINs).

In some embodiments, the policies for a PIN are provided by an AF. In examples where the associated system is 5GS, the AF can be an existing 5G AF that has been modified to include dedicated PIN management capabilities. Such an AF is referred to herein as a “PIN AF.” Alternatively, the policies can be locally configured by the MNO of the 5GS. Such a configuration is applicable in scenarios where the PIN is MNO owned/managed or when PIN policies are static, and therefore, a third party PIN AF is not needed. Note that an AF may be controlled by an MNO or may be controlled by a third party. In the first scenario, the AF is part of the 5G core network. In the second scenario, the AF is referred to as a third-party AF.

In some embodiments, a Policy Control Function (PCF) of the 5GS is also configured with default policies for PIN configurations. As described below, the default policies can be used for PINs that are created dynamically by a UE. A PIN may also be assigned an identifier. Within examples, a PIN identifier can either be pre-provisioned (e.g., a PIN AF configuration or a local MNO configuration) or created dynamically (e.g., xyz@pin.[AMFidentifier].mnc013.mcc234.3gpp). In some examples, the MNO may have a centralized configuration to ensure unique PIN identifiers. Alternatively, a PIN identifier could include an Access & Mobility Management Function (AMF) identifier as part of the PIN identifier, which ensures unique PIN identifiers.

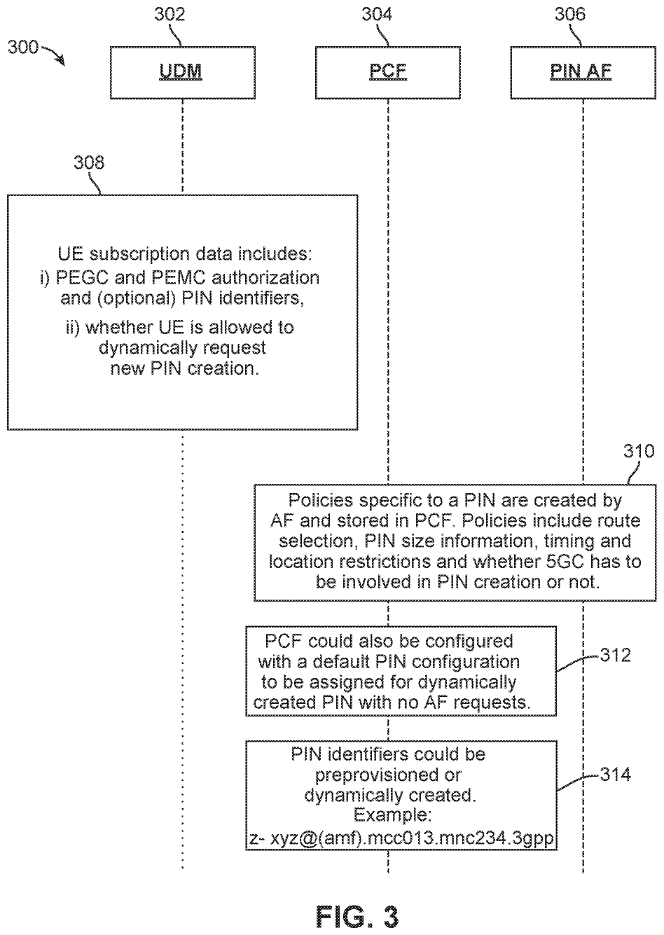

FIG. 3 illustrates a block diagram 300 that illustrates the handling of PIN policies, according to some embodiments. Specifically, FIG. 3 illustrates how PIN policies are handled by Unified Data Management (UDM) 302, PCF 304, and PIN AF 306. UDM 302 and PCF 304 are part of the core network of the 5GS. As shown by block 308, UDM 302 stores UE subscription data, which can include a UE's authorization to act as a PEGC and/or a PEMC. In scenarios where the authorization is restricted, the UE subscription data may include identifiers of the PINs in which the UE has authorization to act as PEGC and/or PEMC. Additionally and/or alternatively, the UE subscription data can include an indication whether the UE is allowed to dynamically request creation of a new PIN (e.g., without prior authorization by the MNO).

As shown by block 310, policies specific to a PIN are created by PIN AF 306 and stored in PCF 304. In some examples, the PIN policies include route selection, PIN size information (e.g., a maximum number of devices), timing and/or location restrictions, and/or an indication whether the 5GS has to be involved in the creation of the PIN. As shown by block 312, PCF 304 can additionally and/or alternatively be configured with a default PIN configuration to be assigned to a dynamically created PIN. As described in more detail below, a dynamically created PIN does not have any PIN AF requests. As shown by block 314, PIN identifiers can be pre-provisioned or dynamically created.

In some embodiments, a PIN AF is responsible for provisioning PIN parameters to the 5GS. PIN attributes, e.g., network size, throughput (e.g., expressed as aggregated maximum bit rate), and capacity, can be used as PIN parameters. Additionally, the PIN AF can subscribe to the 5GS to receive notifications related to PINs. For example, the PIN AF can subscribe to notifications related to PIN networks that meet specific criteria.

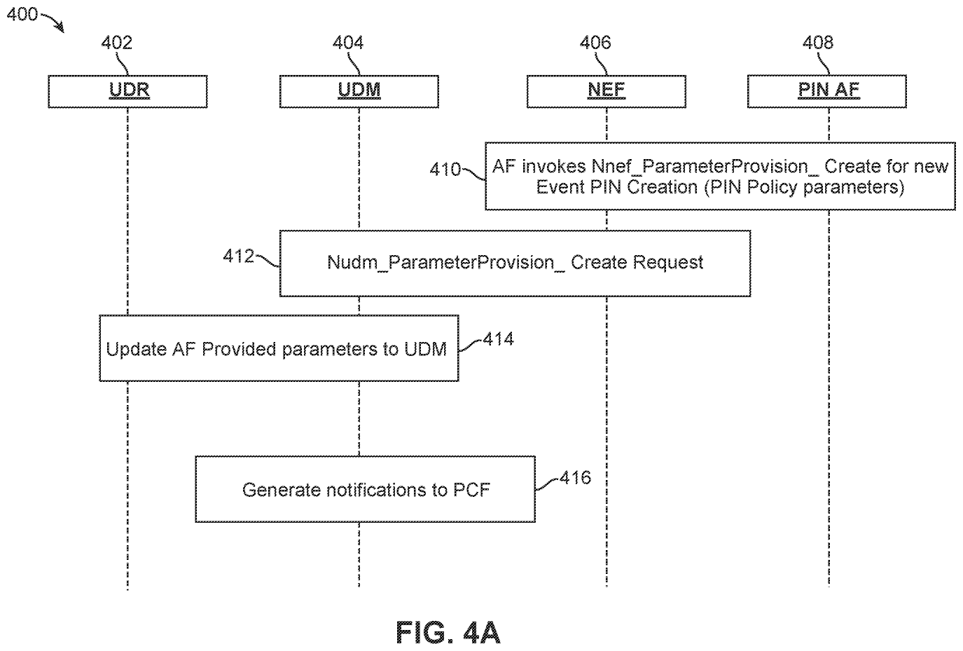

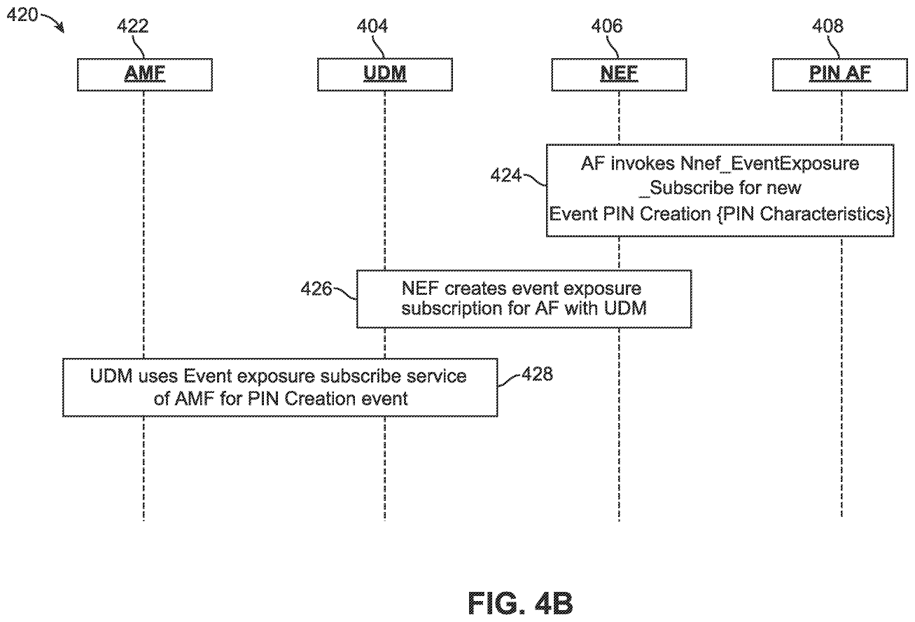

FIG. 4A illustrates a call flow 400 for PIN parameter provisioning, according to some embodiments. The call flow 400 is a modified version of the parameter provisioning described in 3GPP TS 23.502 Section 4.15.6.2. As shown in FIG. 4A, User Data Repository (UDR) instance 402, UDM 404, Network Exposure Function (NEF) 406, and PIN AF 408 are involved in the parameter provisioning. As shown by block 410, PIN AF 408 invokes Nnef_ParameterProvision_Create for a new PIN creation event. PIN AF 408 includes PIN policy parameters in the invoked message that is sent to NEF 406. As shown by block 412, NEF 406 sends UDM 404 a Nudm_ParameterProvision_Create request. As shown by block 414, UDR 402 and UDM 404 are updated with policy parameters provided by PIN AF 408. Once the UDM 404 completes the procedure with the UDR 402, a parameter provisioning response is sent to PIN AF 408, perhaps by NEF 406. As shown by block 416, UDM 404 can generate notifications indicative of the PIN policy parameters to a PCF of the 5GS.

FIG. 4B illustrates a call flow 420 for PIN parameter notification, according to some embodiments. The call flow 420 is a modified version of the parameter notification described in 3GPP TS 23.502 Section 4.15.3.2.3. As shown in FIG. 4B, AMF 422, UDM 404, NEF 406, and PIN AF 408 are involved in the call flow 420. As shown by block 424, PIN AF 408 invokes Nnef_EventExposure_Subscribe for a new PIN creation event. PIN AF 408 includes PIN characteristics in the invoked message that is sent to NEF 406. As shown by block 426, NEF 406 and UDM 404 create an event exposure subscription for PIN AF 408 based on the provided PIN characteristics. As shown by block 428, UDM 404 uses an event exposure subscribe service of AMF 422 for the PIN creation event.

In some embodiments, 3GPP compatible UEs and the 5GS are configured to perform workflows for establishing and configuring PIN networks. The workflows may include one or more of: (i) a first workflow for PIN establishment with pre-provisioning of PIN policies, (ii) a second (or alternate) workflow for PIN establishment with pre-provisioning of PIN policies, (iii) a workflow for user plane authorization for PIN establishment, (iv) a workflow for PIN establishment with dynamic policy updates, (v) a first workflow for UE-initiated creation of a new PIN, (vi) a workflow for UE-initiated creation of a new PIN with the involvement of a PIN AF.

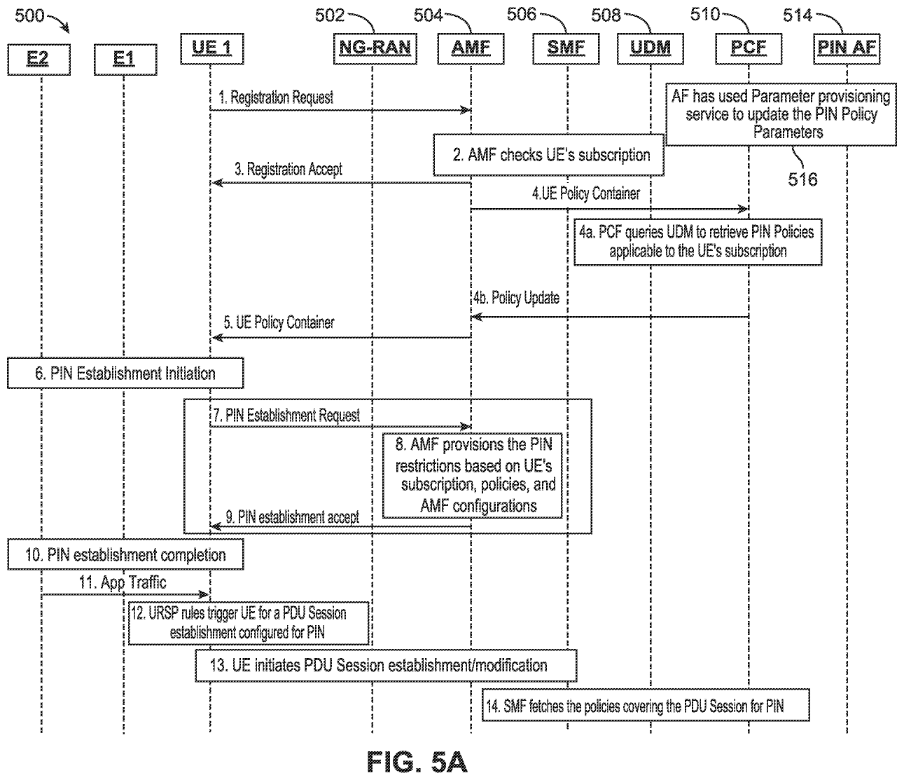

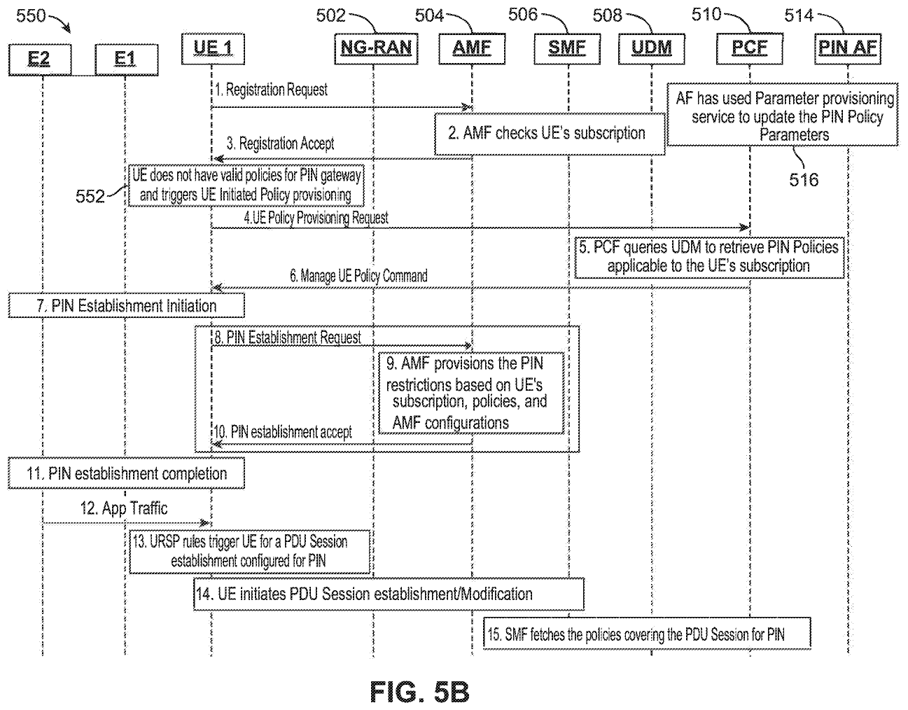

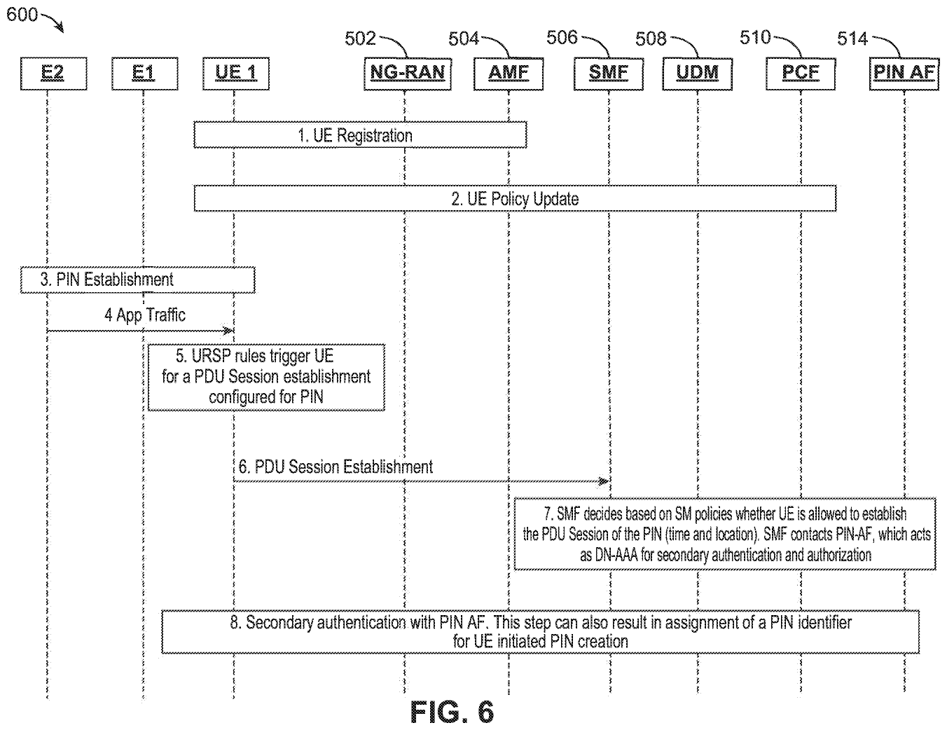

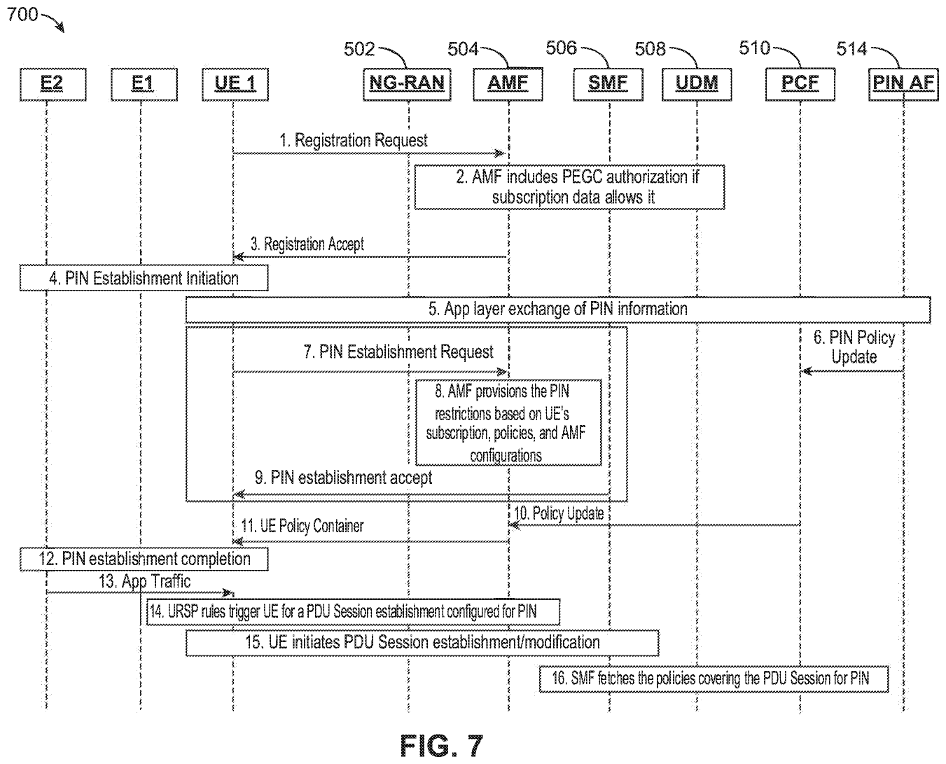

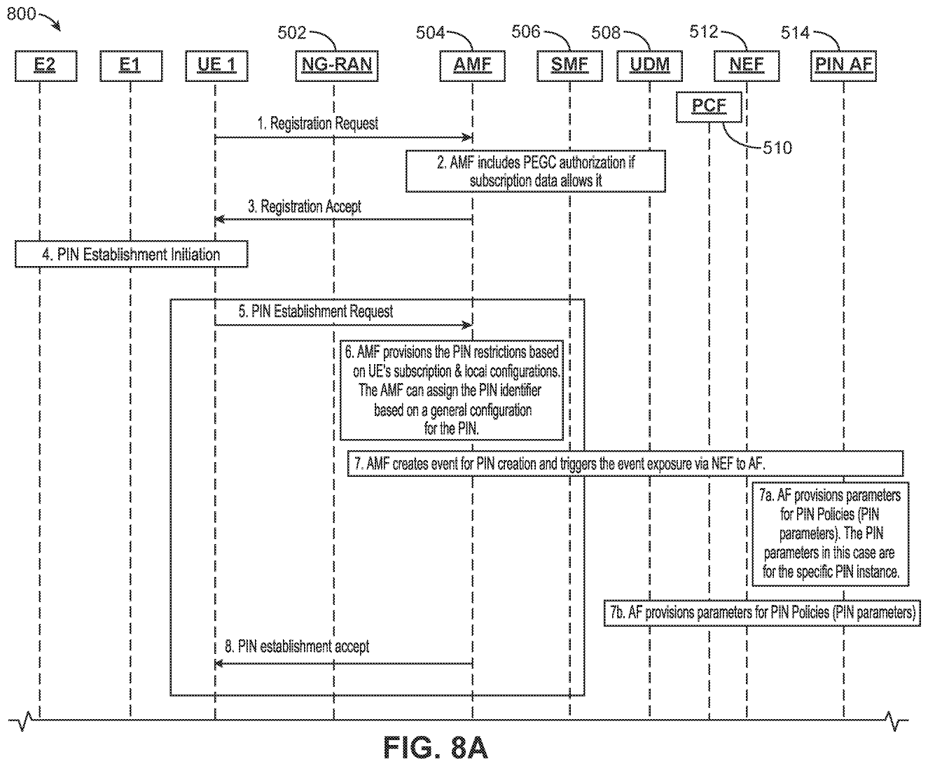

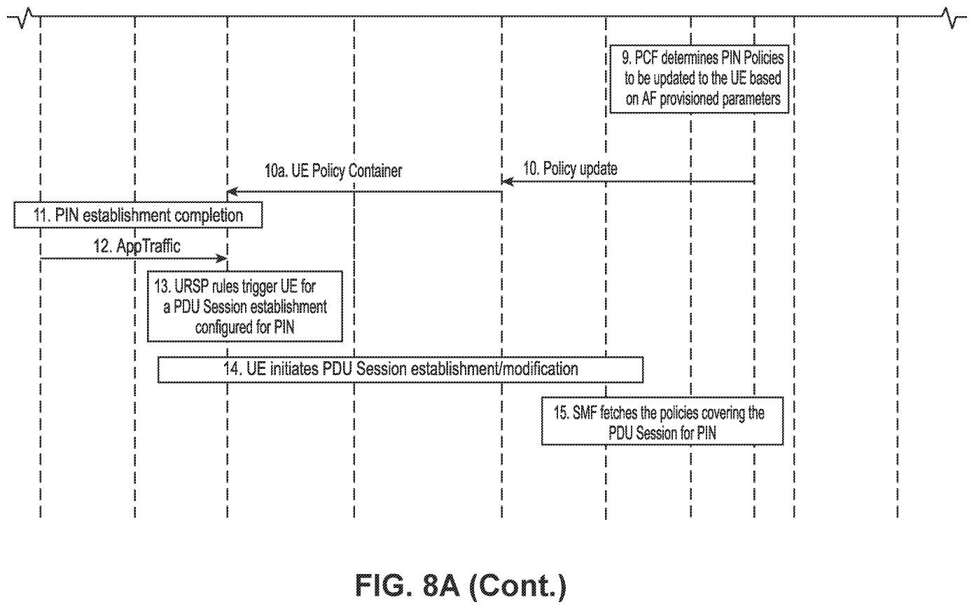

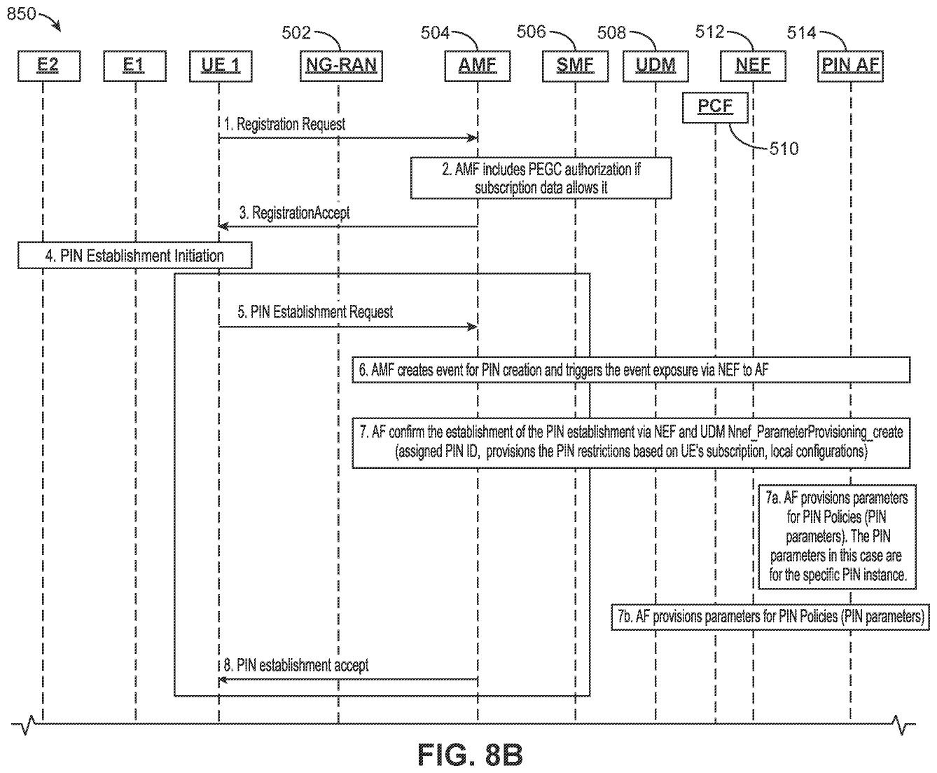

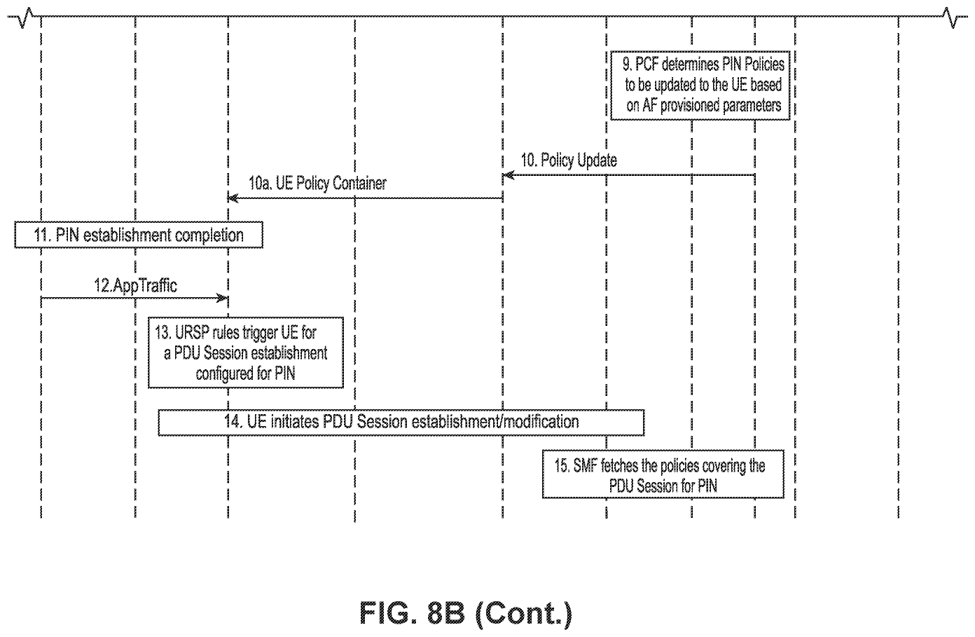

Each of these workflows is described in more detail in connection with FIGS. 5A-8B. FIG. 5A illustrates a call flow 500 for PIN establishment with pre-provisioning of PIN policies. FIG. 5B illustrates an alternate call flow 550 for PIN establishment with pre-provisioning of PIN policies. FIG. 6 illustrates a call flow 600 for user plane based authorization for PIN establishment. FIG. 7 illustrates a call flow 700 for PIN establishment with dynamic policy updates. FIG. 8A illustrates a call flow 800 for UE-initiated creation of a new PIN. FIG. 8B illustrates a call flow 850 for UE-initiated creation of a new PIN with the involvement of a PIN AF. In the examples of these figures, the PIN being established includes a 3GPP-based device (UE-1) and two other devices (E1, E2), which can be 3GPP or non-3GPP-based devices. UE-1 serves as the PEGC and PEMC of the PIN being established. Further, the 5GS includes NG-RAN 502, AMF 504, Session Management Function (SMF) 506, UDM 508, PCF 510, and NEF 512. The 5GS communicates with PIN AF 514, which may be a trusted or untrusted AF. Note that other example arrangements are possible. Also, note that the disclosed call flows can be applied to other wireless communication systems.

Turning to FIG. 5A, the call flow 500 is for PIN establishment using pre-provisioned policies from PIN AF 514. As shown by block 516, PIN AF 514 uses a parameter provisioning process (via NEF 512) to update the core network with PIN policies. As an example, PIN AF 514 can use the PIN policy provisioning call flow 400 described in FIG. 4A. The call flow 500 is based on a registration procedure described in 3GPP TS 23.502 Section 4.2.2.2 and a PDU session establishment procedure described in 3GPP TS 23.502 Section 4.3.2.2.

At step 1, UE-1 registers with the core network of the associated 5GS. In this step, UE-1 generates a registration request that is sent, via NG-RAN 502, to AMF 504. The registration request includes a UE policy container that includes UE-1's PIN related capabilities (e g., PEGC capability and/or PEMC capability). In this example, the UE policy container includes an indication of both PEGC and PEMC capabilities. At step 2, AMF 504 checks UE-1's subscription data, e.g., by communicating with SMF 506 and/or UDM 508, and determines whether UE-1 is allowed to act as PEGC/PEMC. At step 3, and in response to determining that UE-1 is allowed to act as PEGC/PEMC, AMF 504 sends UE-1 a registration accept message. Among other things, the registration accept message includes UE authorizations related to the PIN. For example, the registration accept message can include a PIN gateway authorization, a dynamic PIN authorization (e.g., whether UE-1 is allowed to dynamically create new PINs), among other information.

At step 4, the UE policy container is passed to PCF 510. At step 4a, PCF 510 queries UDM 508 to retrieve one or more PIN policies applicable to UE-1's subscription. The policies applicable to the UE may include one or more sets of PIN attributes and corresponding policies, including URSP. At step 4b, PCF 510 sends a request to AMF 504 to provide the one or more PIN policies UE-1. The request may be sent in a “Namf_Communication_N1N2MessageTransfer” message. In some examples, the PIN policies include a PIN identifier, an indication whether the core network is to be informed of the PIN creation, and/or UE route selection policy (URSP) rules for PIN traffic. The location and time restrictions for PIN traffic may be expressed as Route Selection Validation criteria in the URSP rule corresponding to the PIN. The UE acting as PEGC then takes the restrictions into consideration while initiating PDU Session establishment for PIN traffic. Note that the core network (e.g., the AMF) can require to be informed of PIN creation if certain time/location restriction apply to operations of the PIN. Additionally and/or alternatively, the PIN polices can include policies that are applied for any PIN created in the applicable network.

At step 5, AMF 504 passes the UE policy container to UE-1. At step 6, UE-1, E1, and E2 initiate establishment of the PIN. In examples where the core network is to be informed of the PIN creation, steps 7-9 are performed. At step 7, UE-1 informs the core network of the PIN creation, e.g., by sending a PIN establishment request to AMF 504. The request may include a PIN identifier and/or identifiers of the UE (or UEs) that are operating as PEGC and PEMC. In this example, the request includes a PIN identifier and an identifier of UE-1 (as PEGC/PEMC). At step 8, AMF 504 checks for local restrictions applicable to the PIN, e.g., by checking UE-1's subscription, the applicable PIN policies, and/or AMF configurations. As an example, based on the identified restrictions, AMF 504 can limit the operation of the PIN to a certain time or to a certain location (e.g., for smart a home system installed and maintained by the MNO for a subscriber's home location). The restrictions can be tracking area (TA) wide or cell-specific. At step 9, AMF 504 confirms to UE-1 the PIN establishment and includes additional information on restrictions (if any). For example, the additional information can include a PIN duration and/or a location restriction.

At step 10, the PIN establishment is completed. In this step, UE-1 also selects the applicable PIN policies based on the characteristics of PIN that gets established. At step 11, application traffic originating from one of the PIN elements is directed to a cloud server (not shown in FIG. 5A). Specifically, the application traffic is sent to UE-1, as it serves as the gateway for the PIN. At step 12, UE-1 evaluates the URSP rules for establishing a PDU session (e.g., if a PDU session has not already been established). In this example, the URSP rules trigger a PDU session establishment. At step 13, the PDU session is established (or modified if a PDU session is already established). At step 14, SMF 506 fetches the session management (SM) policies applicable to the PIN, and routes the PIN traffic accordingly.

FIG. 5B illustrates an alternate call flow 550 for PIN establishment using pre-provisioned policies. The call flow 550 can be used in scenarios of UE-initiated policy provisioning. In these scenarios, UE-1 is responsible for initiating policy provisioning. Accordingly, UE-1 communications directly with PCF 510 to request PIN policies.

At steps 1-3, UE-1 performs UE registration by communicating with AMF 504. These steps are similar to steps 1-3 of the call flow 500. As shown by block 552, UE-1, in response to receiving the registration accept message from AMF 504, determines that it does not have valid policies to serve as the PIN gateway and triggers policy provisioning (i.e., UE-initiated policy provisioning). Specifically, at step 4, UE-1 sends a UE policy provisioning request to PCF 510. The request may include a PIN gateway capability. At step 5, PCF 510 queries UDM 508 to retrieve PIN policies applicable to UE-1's subscription. At step 6, PCF 510 sends UE-1 a manage UE policy command. The command can include a PIN identifier, an indication whether the core network is to be informed of the PIN creation, and URSP rules for PIN traffic. As shown by these steps, UE-1 is responsible for initiating policy provisioning. This is contrast to core network initiating policy provisioning as is done in the call flow 500. Steps 7-15 are similar to steps 6-14 of FIG. 5A, respectively.

FIG. 6 illustrates a call flow 600 for user plane based authorization for PIN establishment. In some examples, the call flow 600 is used in scenarios where the PIN is configured to establish a separate PDU session for the PIN traffic.

In the call flow 600, step 1 of UE registration and step 2 of UE policy updates are similar to steps 1-5 of the call flow 500 or steps 1-6 of the call flow 550 (e.g., depending on whether the policy provisioning is network- or UE-initiated). At step 3, the PIN is established locally between UE-1, E1, and E2. At step 4, application traffic from the PIN elements triggers UE-1, which is serving as PEGC. At step 5, UE-1 evaluates the URSP rules for the PIN. In this example, the URSP rules indicate that the PIN is configured to establish a separate PDU session (e.g., separate from the PDU session for the UE traffic). Based on the evaluation of the URSP rules, UE-1 proceeds to establish a new PDU Session with PIN configurations specified by the URSP rules. The PIN configurations can include a dedicated Data Network Name (DNN) and a serving network slice selection assistant information (S-NSSAI).

At step 6, UE-1 sends a PDU session establishment request to SMF 506. At step 7, based on SM policies, SMF 506 evaluates whether it is allowed to establish the new PDU session at the current time and from UE-1's location. If the SMF 506 determines that it is allowed to establish the new PDU session, SMF 506 contacts PIN AF 514, which acts as a Data Network (DN)-authentication, authorization, accounting (AAA) entity, to perform secondary authentication and authorization. At step 8, PIN AF 514 proceeds with the secondary authentication and authorization (e.g., as described in 3GPP TS 23.501 Section 5.6.6).

FIG. 7 illustrates the call flow 700 for PIN Establishment with dynamic policy updates. In some examples, the call flow 700 is used for establishing a PIN using dynamic policies provided by UE-1.

At steps 1-3, UE-1 performs UE registration by communicating with AMF 504. These steps are similar to steps 1-3 of the call flow 500 of FIG. 5A. At step 4, the PIN is established. At step 5, UE-1 exchanges PIN information with PIN AF 514, perhaps using application layer signaling. The PIN information can include PIN policies from UE-1. The PIN policies from UE-1 can, for example, be specified by one or more users of the PIN. Here, UE-1 informs PIN AF about PIN characteristics (or attributes) as part of the application layer exchange of PIN Information. At step 6, PIN AF 514 provides the PIN policies to PCF 510. At steps 7-9, the core network is informed of the PIN establishment. Specifically, at step 7, UE-1 sends a PIN establishment request to AMF 504. The request can include a PIN identifier and identifiers of the one or more UEs serving as PEMC and PEGC. At step 8, AMF 504 provisions the PIN restrictions based on one or more of (i) UE-1's subscription data, (ii) applicable PIN policies, and (iii) AMF configurations. At step 9, AMF 504 sends UE-1 a PIN establishment accept message that includes a PIN duration and/or location restrictions (e.g., TA wide or cell-specific restrictions). In some examples, AMF 504 may provide UE-1 with default PIN policies to be used until UE-1 can be updated with PIN specific policies.

At step 10, PCF 510 sends a policy update to AMF 504 (e.g., based on the policy updates received in step 6), perhaps in a Namf_communication_N1N2_MessageTransfer message. The PIN policies can include a PIN identifier and/or URSP rules for PIN traffic. In turn, AMF 504 sends the policy update to UE-1, perhaps in a UE policy container message. At step 12, PIN establishment is confirmed. Steps 13-16 involve PIN application traffic triggering establishment of a PDU session (e.g., as described in call flow 500).

FIG. 8A illustrates the call flow 800 for UE initiated PIN establishment. At steps 1-3, UE-1 performs UE registration by communicating with AMF 504. These steps are similar to steps 1-3 of the call flow 500 of FIG. 5A. At step 4, discovery of PIN elements and PIN establishment is performed. The discovery and PIN establishment are application layer interactions. At step 5, UE-1 informs the core network of the newly established PIN, perhaps by way of a PIN establishment request sent to AMF 504. The PIN establishment request can include an identifier of the new PIN and/or PIN characteristics (e.g., PIN type, number of PIN elements and/or traffic class). Additionally and/or alternatively, UE-1 provides PIN attributes as part of PIN Establishment Request. In some examples, UE-1 may self-assign a PIN identifier (according to configured MNO parameters). At step 6, AMF 504 provides PIN restrictions, e.g., based on (i) UE-1's subscription, (ii) applicable PIN policies, and (iii) AMF configurations. Additionally, AMF 504 assigns a PIN identifier to the PIN (e.g., confirms a UE provided PIN identifier or assigns a new PIN identifier). At step 7, AMF 504 generates an event for PIN creation and triggers an event exposure via NEF 512 to PIN AF 514. The event exposure communication can include a new PIN creation event with a unique ID. At step 7a, PIN AF 514 decides on PIN policies for the created PIN. At step 7b, PIN AF 514 provisions PIN policies specific to the PIN. In some embodiments, PIN AF 514 is informed of the PIN creation through application layer signaling from UE-1. In these embodiments, step 7 is skipped.

At step 8, the PIN establishment is confirmed to UE-1. Specifically, AMF 504 may send UE-1 a PIN establishment accept message that includes a PIN identifier assignment, a PIN duration, and/or a location restriction (if any). At step 9, PCF 510 determines PIN policies to be provided to UE-1 based on provisioned policies from PIN AF 514. At step 10, the determined PIN policies are provided to AMF 504. At step 10a, the AMF sends the provisioned policies to UE-1 in a UE policy container. At step 11, PIN establishment is completed. Steps 12-15 involve PIN application traffic triggering establishment of a PDU session (e.g., as described in call flow 500).

FIG. 8B illustrates the call flow 850 for a UE initiated PIN establishment with the involvement of PIN AF 514. Generally, the call flow 850 is similar to the call flow 800 except for steps 6-7. At step 6 of the call flow 850, AMF 504 generates an event for PIN creation and triggers an event exposure via NEF 512 to PIN AF 514. And at step 7, PIN AF 514 assigns PIN identifiers (confirms or re-assigns a PIN identifier if UE-1 had already provided one). PIN AF 514 also provides PIN restrictions. The call flow 850 enables PIN AF 514 to be in direct control of authorizing establishment of PIN instances and setting appropriate conditions for operations.

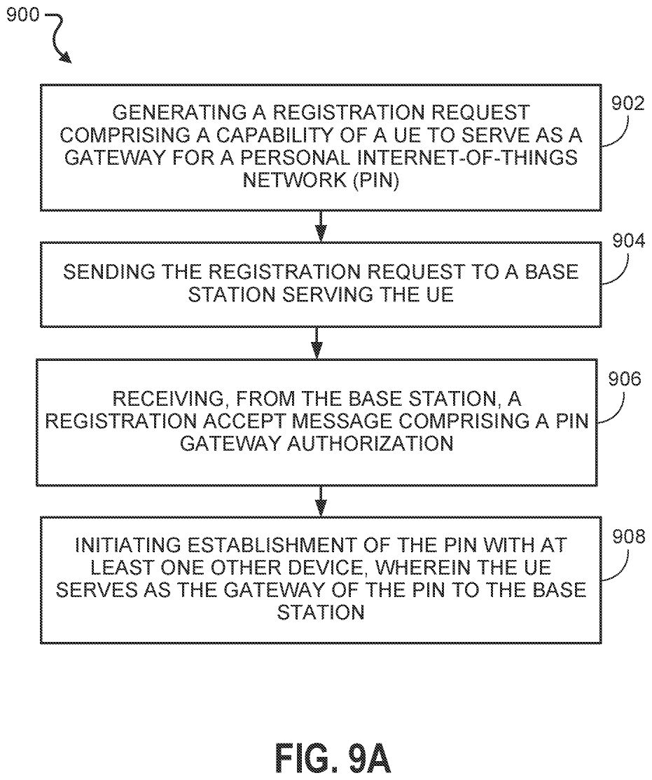

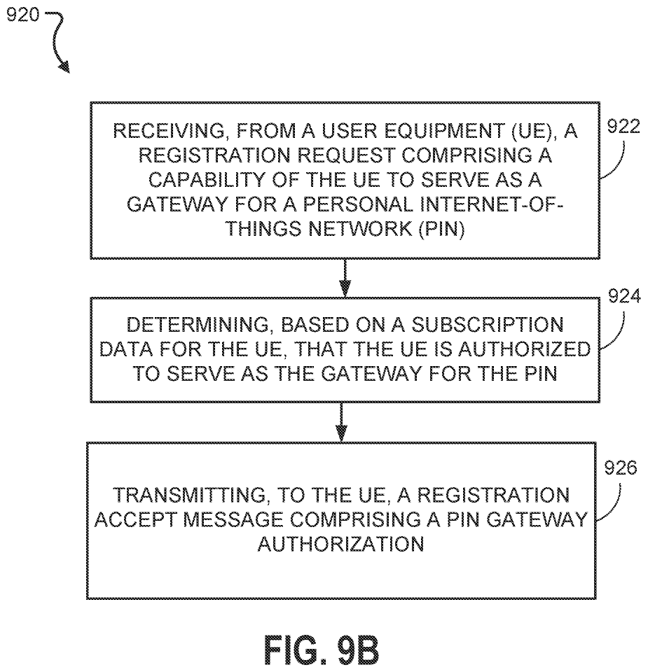

FIG. 9A illustrates a flowchart of an example method 900, according to some implementations. For clarity of presentation, the description that follows generally describes method 900 in the context of the other figures in this description. For example, method 900 can be performed by UE 106 of FIG. 1. It will be understood that method 900 can be performed, for example, by any suitable system, environment, software, hardware, or a combination of systems, environments, software, and hardware, as appropriate. In some implementations, various steps of method 900 can be run in parallel, in combination, in loops, or in any order.

At step 902, method 900 involves generating a registration request comprising a capability of the UE to serve as a gateway for a personal Internet-of-things network (PIN).

At step 904, method 900 involves sending the registration request to a base station serving the UE.

At step 906, method 900 receiving, from the base station, a registration accept message comprising a PIN gateway authorization.

At step 908, method 900 involves initiating establishment of the PIN with at least one other device, wherein the UE serves as the gateway of the PIN to the base station.

In some implementations, the registration request further includes one or more PIN attributes.

In some implementations, the one or more PIN attributes include at least one of: a PIN class, a PIN traffic scope providing a location of PIN traffic, a PIN traffic class, or a PIN size.

In some implementations, the method further including: receiving, from the base station, a UE policy container including at least one of: a PIN identifier, an indication whether to report the establishment of the PIN to the base station, or one or more sets of UE route selection policy (URSP) rules for PIN traffic.

In some implementations, each of the one or more sets is associated with a respective set of PIN attributes.

In some implementations, the method further including: transmitting a PIN establishment request to the base station; receiving a PIN establishment accept message from the base station; and responsively completing the establishment of the PIN.

In some implementations, the PIN establishment request includes at least one of a PIN identifier or an identifier of the UE, and the PIN establishment accept message includes at least one of a PIN duration or a location restriction.

In some implementations, the method further including: receiving application traffic from the at least one other device; determining UE route selection policy (URSP) rules for the application traffic; and based on the URSP rules, initiating establishment of a Protocol Data Unit (PDU) session to route the application traffic.

In some implementations, the method further including: transmitting a UE policy provisioning request to the base station; and receiving a UE policy command from the base station, where the UE policy command includes at least one of: a PIN identifier, an indication whether to report the establishment of the PIN to the base station, or UE route selection policy (URSP) rules for PIN traffic.

In some implementations, transmitting the UE policy provisioning request is performed in response to determining that the UE does not have valid policies for the PIN.

In some implementations, the method further including: transmitting, via application layer signaling, one or more PIN attributes to a PIN application function (AF); and receiving, from the base station, a UE policy container including at least one of: a PIN identifier, an indication whether to report the establishment of the PIN to the base station, or UE route selection policy (URSP) rules for PIN traffic, where the URSP rules are based on the one or more PIN attributes.

In some implementations, the method further including: receiving application traffic from the at least one other device, determining UE route selection policy (URSP) rules for PIN traffic; and based on the URSP rules, determining to establish a new Protocol Data Unit (PDU) session with specified PIN configurations, the specified PIN configurations including a dedicated Data Network Name (DNN) and a serving network slice selection assistant information (S-NSSAI); and transmitting a PDU session establishment request to the base station.

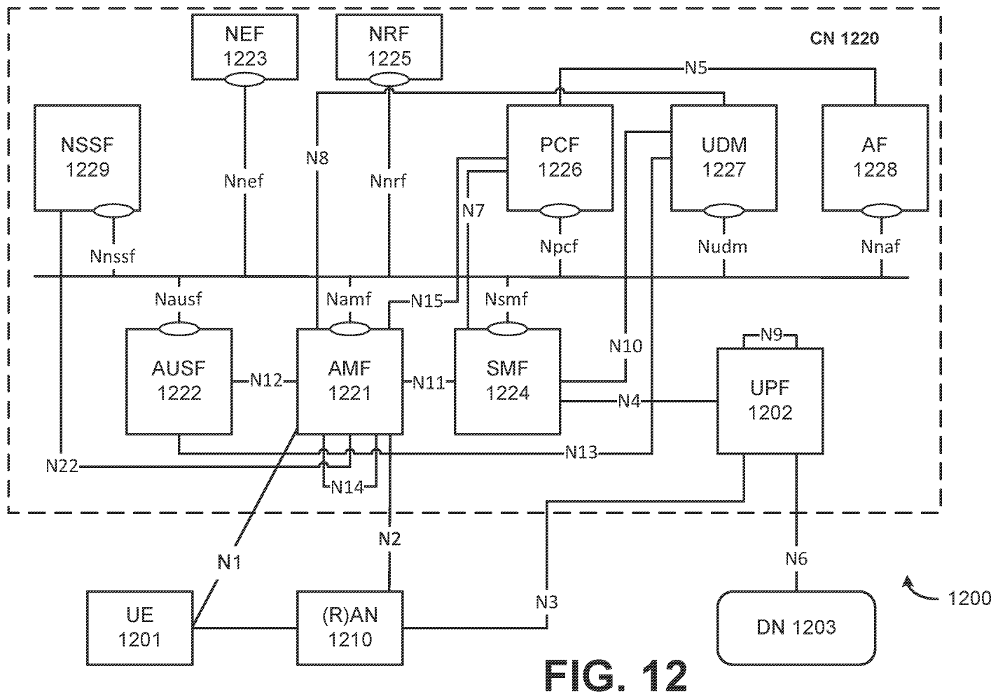

FIG. 9B illustrates a flowchart of an example method 920, according to some implementations. For clarity of presentation, the description that follows generally describes method 920 in the context of the other figures in this description. For example, method 920 can be performed by CN 1220 of FIG. 12. It will be understood that method 920 can be performed, for example, by any suitable system, environment, software, hardware, or a combination of systems, environments, software, and hardware, as appropriate. In some implementations, various steps of method 920 can be run in parallel, in combination, in loops, or in any order.

At 922, method 920 involves receiving, from a user equipment (UE), a registration request comprising a capability of the UE to serve as a gateway for a personal Internet-of-things network (PIN).

At 924, method 900 involves determining, based on a subscription data for the UE, that the UE is authorized to serve as the gateway for the PIN.

At 926, method 900 involves transmitting, to the UE, a registration accept message comprising a PIN gateway authorization.

In some implementations, the method further including: determining, based on the subscription data for the UE, one or more PIN policies for the PIN; and transmitting the one or more PIN policies to the UE.

In some implementations, the one or more PIN policies include at least one of: a PIN identifier, an indication whether to report the establishment of the PIN to the base station, or UE route selection policy (URSP) rules for PIN traffic.

In some implementations, the one or more PIN policies are received from a PIN application function (AF).

In some implementations, the one or more PIN policies are default PIN policies.

In some implementations, the method further including: receiving a PIN establishment request from the UE, the PIN establishment request including at least one of: a PIN identifier, a UE identifier, or one or more PIN attributes; provisioning, based on the subscription data for the UE, one or more restrictions for the PIN; and communicating a PIN establishment accept message to the UE, the PIN establishment accept message including the one or more restrictions for the PIN.

In some implementations, the method further including: in response to receiving the PIN establishment request, triggering an event exposure notification to a PIN application function (AF), the event exposure notification including the one or more PIN attributes; receiving one or more PIN policies from the PIN AF; determining, based on the one or more policies, a PIN policy update to provide to the UE; and communicating the PIN policy update to the UE.

In some implementations, the method further including: receiving, from the UE, a request to establish a new Protocol Data Unit (PDU) session, the request including a dedicated Data Network Name (DNN) and a serving network slice selection assistant information (S-NSSAI); determining, based on one or more session management (SM) policies, that the UE is allowed to establish the new PDU session at a current time and a current UE location; and communicating with a PIN application function (AF) to perform secondary authentication and authorization of the request to establish the new PDU session, where the PIN AF serves as a Data Network (DN)-authentication, authorization, accounting (AAA) entity.

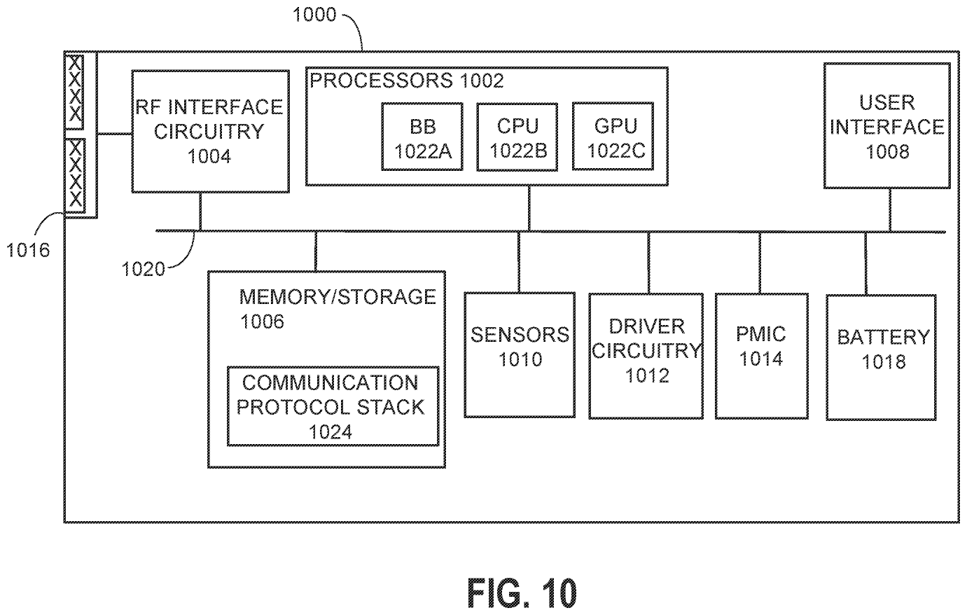

FIG. 10 illustrates a UE 1000, in accordance with some embodiments. The UE 1000 may be similar to and substantially interchangeable with UE 106 of FIG. 1.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, antenna structure 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some embodiments, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1004. The baseband processor circuitry 1022A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some embodiments, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1016.

In various embodiments, the RF interface circuitry 1004 may be configured to transmit/receive signals in a manner compatible with NR access technologies.

The antenna 1016 may include antenna elements to convert electrical signals into radio waves to travel through the air and to convert received radio waves into electrical signals. The antenna elements may be arranged into one or more antenna panels. The antenna 1016 may have antenna panels that are omnidirectional, directional, or a combination thereof to enable beamforming and multiple input, multiple output communications. The antenna 1016 may include microstrip antennas, printed antennas fabricated on the surface of one or more printed circuit boards, patch antennas, phased array antennas, etc. The antenna 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors), pressure sensors, barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensors 1010 and control and allow access to sensors 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some embodiments, the PMIC 1014 may control, or otherwise be part of, various power saving mechanisms of the UE 1000 including DRX as discussed herein. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

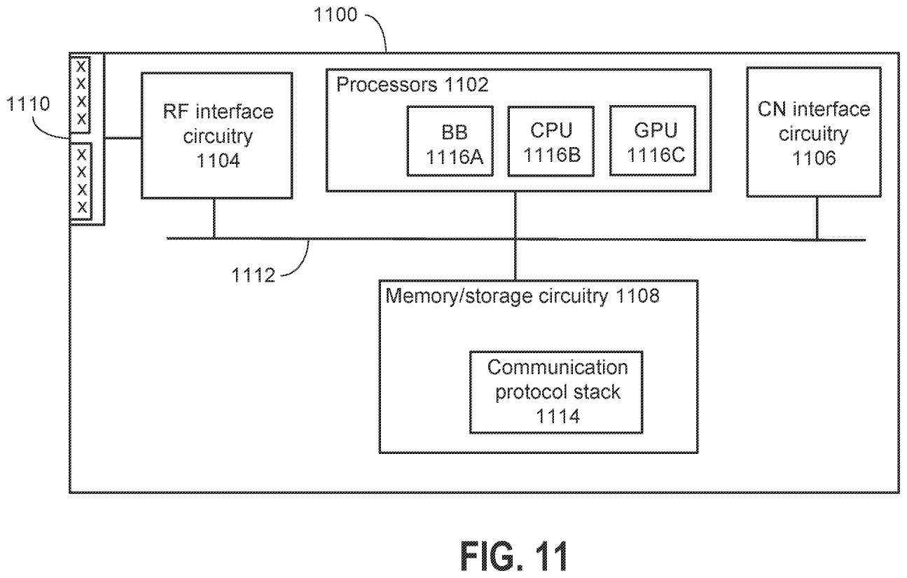

FIG. 11 illustrates an access node 1100 (e.g., a base station or gNB), in accordance with some embodiments. The access node 1100 may include processors 1102, RF interface circuitry 1104, core network (CN) interface circuitry 1106, memory/storage circuitry 1108, and antenna structure 1110.

The components of the access node 1100 may be coupled with various other components over one or more interconnects 1112. The processors 1102, RF interface circuitry 1104, memory/storage circuitry 1108 (including communication protocol stack 1114), antenna structure 1110, and interconnects 1112 may be similar to like-named elements shown and described with respect to FIG. 10. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various embodiments, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 1100 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 1100; a MAC/PHY split wherein RRC, PDCP, RLC, and MAC layers are operated by the CRAN/vBBUP and the PHY layer is operated by the access node 1100; or a “lower PHY” split wherein RRC, PDCP, RLC, MAC layers and upper portions of the PHY layer are operated by the CRAN/vBBUP and lower portions of the PHY layer are operated by the access node 1100.

In V2X scenarios, the access node 1100 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

FIG. 12 illustrates an architecture of a system 1200 including a core network (CN) 1220 in accordance with various embodiments. The system 1200 is shown to include a UE 1201, which may be the same or similar to the UE 1000 discussed previously; a (R)AN 1210, which may be the same or similar to the RAN 114 discussed previously; and a DN 1203, which may be, for example, operator services, Internet access or 3rd party services; and a 5GC 1220. The 5GC 1220 may include an AUSF 1222; an AMF 1221; a SMF 1224; a NEF 1223; a PCF 1226; a NRF 1225; a UDM 1227; an AF 1228; a UPF 1202; and a NSSF 1229. In some embodiments, AMF 1221 may be the same or similar to AMF 422 of FIG. 4B and/or AMF 504 of FIGS. 5A-8B. The AF 1228 may be the same or similar to PIN AF 306 of FIG. 3, PIN AF 408 of FIGS. 4A-4B, and/or PIN AF 514 of FIGS. 5A-8B. The UDM 1227 may be the same or similar to UDM 404 of FIGS. 4A-4B and/or UDM 508 of FIGS. 5A-8B. The NEF 1223 may be the same or similar to NEF 406 of FIG. 4A-4B and/or NEF 512 of FIGS. 8A-8B. The SMF 1224 may be the same or similar to SMF 506 of FIGS. 5A-8B, and PCF 1226 may be the same or similar to PCF 510 of FIGS. 5A-8B. The RAN 1210 may be the same or similar NG-RAN 502 of FIGS. 5A-8B.

The UPF 1202 may act as an anchor point for intra-RAT and inter-RAT mobility, an external PDU session point of interconnect to DN 1203, and a branching point to support multi-homed PDU session. The UPF 1202 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. UPF 1202 may include an uplink classifier to support routing traffic flows to a data network. The DN 1203 may represent various network operator services, Internet access, or third party services. DN 1203 may include, or be similar to, application server XQ30 discussed previously. The UPF 1202 may interact with the SMF 1224 via an N4 reference point between the SMF 1224 and the UPF 1202.

The AUSF 1222 may store data for authentication of UE 1201 and handle authentication-related functionality. The AUSF 1222 may facilitate a common authentication framework for various access types. The AUSF 1222 may communicate with the AMF 1221 via an N12 reference point between the AMF 1221 and the AUSF 1222; and may communicate with the UDM 1227 via an N13 reference point between the UDM 1227 and the AUSF 1222. Additionally, the AUSF 1222 may exhibit an Nausf service-based interface.

The AMF 1221 may be responsible for registration management (e.g., for registering UE 1201, etc.), connection management, reachability management, mobility management, and lawful interception of AMF-related events, and access authentication and authorization. The AMF 1221 may be a termination point for the N11 reference point between the AMF 1221 and the SMF 1224. The AMF 1221 may provide transport for SM messages between the UE 1201 and the SMF 1224, and act as a transparent proxy for routing SM messages. AMF 1221 may also provide transport for SMS messages between UE 1201 and an SMSF (not shown by FIG. 12). AMF 1221 may act as SEAF, which may include interaction with the AUSF 1222 and the UE 1201, receipt of an intermediate key that was established as a result of the UE 1201 authentication process. Where USIM based authentication is used, the AMF 1221 may retrieve the security material from the AUSF 1222. AMF 1221 may also include a SCM function, which receives a key from the SEA that it uses to derive access-network specific keys. Furthermore, AMF 1221 may be a termination point of a RAN CP interface, which may include or be an N2 reference point between the (R)AN 1210 and the AMF 1221; and the AMF 1221 may be a termination point of NAS (N1) signaling, and perform NAS ciphering and integrity protection.

AMF 1221 may also support NAS signaling with a UE 1201 over an N3 IWF interface. The N3IWF may be used to provide access to untrusted entities. N3IWF may be a termination point for the N2 interface between the (R)AN 1210 and the AMF 1221 for the control plane, and may be a termination point for the N3 reference point between the (R)AN 1210 and the UPF 1202 for the user plane. As such, the AMF 1221 may handle N2 signaling from the SMF 1224 and the AMF 1221 for PDU sessions and QoS, encapsulate/de-encapsulate packets for IPSec and N3 tunneling, mark N3 user-plane packets in the uplink, and enforce QoS corresponding to N3 packet marking taking into account QoS requirements associated with such marking received over N2. N3IWF may also relay uplink and downlink control-plane NAS signaling between the UE 1201 and AMF 1221 via an N1 reference point between the UE 1201 and the AMF 1221, and relay uplink and downlink user-plane packets between the UE 1201 and UPF 1202. The N3IWF also provides mechanisms for IPsec tunnel establishment with the UE 1201. The AMF 1221 may exhibit an Namf service-based interface, and may be a termination point for an N14 reference point between two AMFs 1221 and an N17 reference point between the AMF 1221 and a 5G-EIR (not shown by FIG. 12).

The UE 1201 may need to register with the AMF 1221 in order to receive network services. RM is used to register or deregister the UE 1201 with the network (e.g., AMF 1221), and establish a UE context in the network (e.g., AMF 1221). The UE 1201 may operate in an RM-REGISTERED state or an RM-DEREGISTERED state. In the RM DEREGISTERED state, the UE 1201 is not registered with the network, and the UE context in AMF 1221 holds no valid location or routing information for the UE 1201 so the UE 1201 is not reachable by the AMF 1221. In the RM REGISTERED state, the UE 1201 is registered with the network, and the UE context in AMF 1221 may hold a valid location or routing information for the UE 1201 so the UE 1201 is reachable by the AMF 1221. In the RM-REGISTERED state, the UE 1201 may perform mobility Registration Update procedures, perform periodic Registration Update procedures triggered by expiration of the periodic update timer (e.g., to notify the network that the UE 1201 is still active), and perform a Registration Update procedure to update UE capability information or to re-negotiate protocol parameters with the network, among others.

The AMF 1221 may store one or more RM contexts for the UE 1201, where each RM context is associated with a specific access to the network. The RM context may be a data structure, database object, etc. That indicates or stores, inter alia, a registration state per access type and the periodic update timer. The AMF 1221 may also store a 5GC MM context that may be the same or similar to the (E)MM context discussed previously. In various embodiments, the AMF 1221 may store a CE mode B Restriction parameter of the UE 1201 in an associated MM context or RM context. The AMF 1221 may also derive the value, when needed, from the UE's usage setting parameter already stored in the UE context (and/or MM/RM context).

CM may be used to establish and release a signaling connection between the UE 1201 and the AMF 1221 over the N1 interface. The signaling connection is used to enable NAS signaling exchange between the UE 1201 and the CN 1220, and comprises both the signaling connection between the UE and the AN (e.g., RRC connection or UE-N3IWF connection for non-3GPP access) and the N2 connection for the UE 1201 between the AN (e.g., RAN 1210) and the AMF 1221. The UE 1201 may operate in one of two CM states, CM-IDLE mode or CM-CONNECTED mode. When the UE 1201 is operating in the CM-IDLE state/mode, the UE 1201 may have no NAS signaling connection established with the AMF 1221 over the N1 interface, and there may be (R)AN 1210 signaling connection (e.g., N2 and/or N3 connections) for the UE 1201. When the UE 1201 is operating in the CM-CONNECTED state/mode, the UE 1201 may have an established NAS signaling connection with the AMF 1221 over the N1 interface, and there may be a (R)AN 1210 signaling connection (e.g., N2 and/or N3 connections) for the UE 1201. Establishment of an N2 connection between the (R)AN 1210 and the AMF 1221 may cause the UE 1201 to transition from CM-IDLE mode to CM-CONNECTED mode, and the UE 1201 may transition from the CM-CONNECTED mode to the CM-IDLE mode when N2 signaling between the (R)AN 1210 and the AMF 1221 is released.

The SMF 1224 may be responsible for SM (e.g., session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 1201 and a data network (DN) 1203 identified by a Data Network Name (DNN). PDU sessions may be established upon UE 1201 request, modified upon UE 1201 and 5GC 1220 request, and released upon UE 1201 and 5GC 1220 request using NAS SM signaling exchanged over the N1 reference point between the UE 1201 and the SMF 1224. Upon request from an application server, the 5GC 1220 may trigger a specific application in the UE 1201. In response to receipt of the trigger message, the UE 1201 may pass the trigger message (or relevant parts/information of the trigger message) to one or more identified applications in the UE 1201. The identified application(s) in the UE 1201 may establish a PDU session to a specific DNN. The SMF 1224 may check whether the UE 1201 requests are compliant with user subscription information associated with the UE 1201. In this regard, the SMF 1224 may retrieve and/or request to receive update notifications on SMF 1224 level subscription data from the UDM 1227.

The SMF 1224 may include the following roaming functionality: handling local enforcement to apply QoS SLAs (VPLMN); charging data collection and charging interface (VPLMN); lawful intercept (in VPLMN for SM events and interface to LI system); and support for interaction with external DN for transport of signaling for PDU session authorization/authentication by external DN. An N16 reference point between two SMFs 1224 may be included in the system 1200, which may be between another SMF 1224 in a visited network and the SMF 1224 in the home network in roaming scenarios. Additionally, the SMF 1224 may exhibit the Nsmf service-based interface.

The NEF 1223 may provide means for securely exposing the services and capabilities provided by 3GPP network functions for third party, internal exposure/re-exposure, Application Functions (e.g., AF 1228), edge computing or fog computing systems, etc. In such embodiments, the NEF 1223 may authenticate, authorize, and/or throttle the AFs NEF 1223 may also translate information exchanged with the AF 1228 and information exchanged with internal network functions. For example, the NEF 1223 may translate between an AF-Service-Identifier and an internal 5GC information. NEF 1223 may also receive information from other network functions (NFs) based on exposed capabilities of other network functions. This information may be stored at the NEF 1223 as structured data, or at a data storage NF using standardized interfaces. The stored information can then be re-exposed by the NEF 1223 to other NFs and AFs, and/or used for other purposes such as analytics. Additionally, the NEF 1223 may exhibit an Nnef service-based interface.

The NRF 1225 may support service discovery functions, receive NF discovery requests from NF instances, and provide the information of the discovered NF instances to the NF instances. NRF 1225 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1225 may exhibit the Nnrf service-based interface.

The PCF 1226 may provide policy rules to control plane function(s) to enforce them, and may also support unified policy framework to govern network behavior. The PCF 1226 may also implement an FE to access subscription information relevant for policy decisions in a UDR of the UDM 1227. The PCF 1226 may communicate with the AMF 1221 via an N15 reference point between the PCF 1226 and the AMF 1221, which may include a PCF 1226 in a visited network and the AMF 1221 in case of roaming scenarios. The PCF 1226 may communicate with the AF 1228 via an N5 reference point between the PCF 1226 and the AF 1228; and with the SMF 1224 via an N7 reference point between the PCF 1226 and the SMF 1224. The system 1200 and/or CN 1220 may also include an N24 reference point between the PCF 1226 (in the home network) and a PCF 1226 in a visited network. Additionally, the PCF 1226 may exhibit an Npcf service-based interface.

The UDM 1227 may handle subscription-related information to support the network entities' handling of communication sessions, and may store subscription data of UE 1201. For example, subscription data may be communicated between the UDM 1227 and the AMF 1221 via an N8 reference point between the UDM 1227 and the AMF. The UDM 1227 may include two parts, an application FE and a UDR (the FE and UDR are not shown by FIG. 12). The UDR may store subscription data and policy data for the UDM 1227 and the PCF 1226, and/or structured data for exposure and application data (including PFDs for application detection, application request information for multiple UEs 1201) for the NEF 1223. The Nudr service-based interface may be exhibited by the UDR to allow the UDM 1227, PCF 1226, and NEF 1223 to access a particular set of the stored data, as well as to read, update (e.g., add, modify), delete, and subscribe to notification of relevant data changes in the UDR. The UDM may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 1224 via an N10 reference point between the UDM 1227 and the SMF 1224. UDM 1227 may also support SMS management, wherein an SMS-FE implements the similar application logic as discussed previously. Additionally, the UDM 1227 may exhibit the Nudm service-based interface.

The AF 1228 may provide application influence on traffic routing, provide access to the NCE, and interact with the policy framework for policy control. The NCE may be a mechanism that allows the 5GC 1220 and AF 1228 to provide information to each other via NEF 1223, which may be used for edge computing implementations. In such implementations, the network operator and third party services may be hosted close to the UE 1201 access point of attachment to achieve an efficient service delivery through the reduced end-to-end latency and load on the transport network. For edge computing implementations, the 5GC may select a UPF 1202 close to the UE 1201 and execute traffic steering from the UPF 1202 to DN 1203 via the N6 interface. This may be based on the UE subscription data, UE location, and information provided by the AF 1228. In this way, the AF 1228 may influence UPF (re)selection and traffic routing. Based on operator deployment, when AF 1228 is considered to be a trusted entity, the network operator may permit AF 1228 to interact directly with relevant NFs. Additionally, the AF 1228 may exhibit an Naf service-based interface.

The NSSF 1229 may select a set of network slice instances serving the UE 1201. The NSSF 1229 may also determine allowed NSSAI and the mapping to the subscribed S-NSSAIs, if needed. The NSSF 1229 may also determine the AMF set to be used to serve the UE 1201, or a list of candidate AMF(s) 1221 based on a suitable configuration and possibly by querying the NRF 1225. The selection of a set of network slice instances for the UE 1201 may be triggered by the AMF 1221 with which the UE 1201 is registered by interacting with the NSSF 1229, which may lead to a change of AMF 1221. The NSSF 1229 may interact with the AMF 1221 via an N22 reference point between AMF 1221 and NSSF 1229; and may communicate with another NSSF 1229 in a visited network via an N31 reference point (not shown by FIG. 12). Additionally, the NSSF 1229 may exhibit an Nnssf service-based interface.

As discussed previously, the CN 1220 may include an SMSF, which may be responsible for SMS subscription checking and verification, and relaying SM messages to/from the UE 1201 to/from other entities, such as an SMS-GMSC/IWMSC/SMS-router. The SMS may also interact with AMF 1221 and UDM 1227 for a notification procedure that the UE 1201 is available for SMS transfer (e.g., set a UE not reachable flag, and notifying UDM 1227 when UE 1201 is available for SMS).

The CN 1220 may also include other elements that are not shown by FIG. 12, such as a Data Storage system/architecture, a 5G-EIR, a SEPP, and the like. The Data Storage system may include a SDSF, an UDSF, and/or the like. Any NF may store and retrieve unstructured data into/from the UDSF (e.g., UE contexts), via N18 reference point between any NF and the UDSF (not shown by FIG. 12). Individual NFs may share a UDSF for storing their respective unstructured data or individual NFs may each have their own UDSF located at or near the individual NFs. Additionally, the UDSF may exhibit an Nudsf service-based interface (not shown by FIG. 12). The 5G-EIR may be an NF that checks the status of PEI for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 12 for clarity. In one example, the CN 1220 may include an Nx interface, which is an inter-CN interface between the MME (e.g., MME XR121) and the AMF 1221 in order to enable interworking between CN 1220 and CN XR120. Other example interfaces/reference points may include an N5g-EIR service-based interface exhibited by a 5G-EIR, an N27 reference point between the NRF in the visited network and the NRF in the home network; and an N31 reference point between the NSSF in the visited network and the NSSF in the home network.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a personal Internet-of-things (IoT) network (PIN) that is operated in cooperation with an associated wireless communication system.

Example 2 is the PIN of Example 1, wherein the associated wireless communication system is a 5^{th} Generation System (5GS).

Example 3 is the PIN of Example 1, wherein the network is a smart home network or a network of wearable devices.

Example 4 is the PIN of Example 1, wherein the network includes a plurality of elements.

Example 5 is the PIN of Example 4, wherein at least one of the plurality of elements is part of more than one PIN.

Example 6 is the PIN of Example 4, wherein the plurality of elements include a 3GPP-based device.

Example 7 is the PIN of Example 5, wherein the 3GPP-based device serves as a gateway between the PIN and external systems.

Example 8 is the PIN of Example 1, wherein the PIN is created by a user.

Example 9 is the PIN of Example 1, wherein the PIN is created by the associated wireless communication system.

Example 10 is the PIN of Example 1, wherein the PIN is created by an application function (AF) dedicated to PINs.

Example 11 is the PIN of Example 1, wherein the associated wireless communication system also manages provisioning of PIN policies, authentication of elements, and onboarding of elements for the PIN.

Example 12 is the PIN of Example 1, wherein the PIN is assigned one or more attributes.

Example 13 is the PIN of Example 12, wherein the PIN attributes include a PIN class, a PIN traffic scope, a PIN traffic class, and a PIN size.

Example 14 is the PIN of Example 13, wherein the categories within the PIN class include a private PIN, a public PIN, and a personal body area PIN, wherein the categories within the PIN traffic scope include: local, partially local, and cloud, wherein the categories within the PIN traffic class include high priority traffic and low priority traffic, and wherein the PIN size is a number of elements, an aggregated load of the PIN, or a duty cycle of the elements of the PIN.

Example 15 is the PIN of Example 13, elements of the PIN are configured with a PIN layer that serves as a common interface for exchanging information between the elements.

Example 16 is the PIN of Example 1, wherein the wireless communication system stored UE subscription data for a UE of the PIN, and wherein the UE subscription data includes (i) an authorization to act as a PEGC and/or a PEMC, and/or (ii) information indicating whether the UE is allowed to dynamically request creation of a new PIN.

Example 17 is the PIN of Example 1, wherein authorization to act as PEGC and/or PEMC is an open authorization or is a restricted authorization.

Example 18 is a method for a user equipment (UE), the method comprising: generating a registration request comprising a capability of the UE to serve as a gateway for a personal Internet-of-things network (PIN); sending the registration request to a base station serving the UE; receiving, from the base station, a registration accept message comprising a PIN gateway authorization; and initiating establishment of the PIN with at least one other device, wherein the UE serves as the gateway of the PIN to the base station.

Example 19 is the method of Example 18, wherein the registration request further comprises one or more PIN attributes.

Example 20 is the method of Example 19, wherein the one or more PIN attributes comprise at least one of: a PIN class, a PIN traffic scope providing a location of PIN traffic, a PIN traffic class, or a PIN size.

Example 21 is the method of Example 17, the method further comprising receiving, from the base station, a UE policy container comprising at least one of: a PIN identifier, an indication whether to report the establishment of the PIN to the base station, or UE route selection policy (URSP) rules for PIN traffic.

Example 22 is the method of Example 17, the method further comprising transmitting a PIN establishment request to the base station; receiving a PIN establishment accept message from the base station; and responsively completing the establishment of the PIN.

Example 23 is the method of Example 22, wherein the PIN establishment request comprises at least one of a PIN identifier or an identifier of the UE, and the PIN establishment accept message comprises at least one of a PIN duration or a location restriction.

Example 24 is the method of Example 17, the method further comprising: receiving application traffic from the at least one other device; determining UE route selection policy (URSP) rules for the application traffic; and based on the URSP rules, initiating establishment of a Protocol Data Unit (PDU) session to route the application traffic.

Example 25 is the method of Example 17, the method further comprising: transmitting a UE policy provisioning request to the base station; and receiving a UE policy command from the base station, wherein the UE policy command comprises at least one of: a PIN identifier, an indication whether to report the establishment of the PIN to the base station, or UE route selection policy (URSP) rules for PIN traffic.

Example 26 is the method of Example 25, wherein transmitting the UE policy provisioning request is performed in response to determining that the UE does not have valid policies for the PIN.

Example 27 is the method of Example 17, the method further comprising: transmitting, via application layer signaling, PIN information to a PIN application function (AF); and receiving, from the base station, a UE policy container comprising at least one of: a PIN identifier, an indication whether to report the establishment of the PIN to the base station, or UE route selection policy (URSP) rules for PIN traffic, wherein the URSP rules are based on the PIN information.

Example 28 is the method of Example 17, the method further comprising: receiving application traffic from the at least one other device; determining UE route selection policy (URSP) rules for PIN traffic; and based on the URSP rules, determining to establish a new Protocol Data Unit (PDU) session with specified PIN configurations, the specified PIN configurations comprising a dedicated Data Network Name (DNN) and a serving network slice selection assistant information (S-NSSAI); and transmitting a PDU session establishment request to the base station.

Example 29 is a method comprising: receiving, from a user equipment (UE), a registration request comprising a capability of the UE to serve as a gateway for a personal Internet-of-things network (PIN); determining, based on a subscription data for the UE, that the UE is authorized to serve as the gateway for the PIN; and transmitting, to the UE, a registration accept message comprising a PIN gateway authorization.

Example 30 is the method of Example 29, the method further comprising: determining, based on the subscription data for the UE, one or more PIN policies for the PIN; and transmitting the one or more PIN policies to the UE.

Example 31 is the method of Example 30, wherein the one or more PIN policies comprise at least one of: a PIN identifier, an indication whether to report the establishment of the PIN to the base station, or UE route selection policy (URSP) rules for PIN traffic.

Example 32 is the method of Example 30, wherein the one or more PIN policies are received from a PIN application function (AF).

Example 33 is the method of Example 30, wherein the one or more PIN policies are default PIN policies.

Example 34 is the method of Example 29, the method further comprising: receiving a PIN establishment request from the UE, the PIN establishment request comprising a PIN identifier and a UE identifier; provisioning, based on the subscription data for the UE, one or more restrictions for the PIN; and communicating a PIN establishment accept message to the UE, the PIN establishment accept message comprising the one or more restrictions for the PIN.

Example 35 is the method of Example 34, the method further comprising: in response to receiving the PIN establishment request, triggering an event exposure notification to a PIN application function (AF); receiving one or more PIN policies from the PIN AF; determining, based on the one or more policies, a PIN policy update to provide to the UE; and communicating the PIN policy update to the UE.

Example 36 is the method of Example 29, the method further comprising: receiving, from the UE, a request to establish a new Protocol Data Unit (PDU) session, the request comprising a dedicated Data Network Name (DNN) and a serving network slice selection assistant information (S-NSSAI); determining, based on one or more session management (SM) policies, that the UE is allowed to establish the new PDU session at a current time and a current UE location; and communicating with a PIN application function (AF) to perform secondary authentication and authorization of the request to establish the new PDU session, wherein the PIN AF serves as a Data Network (DN)-authentication, authorization, accounting (AAA) entity.

Example 37 includes a personal Internet-of-things (PIN) Application Function (AF).

Example 38 is the PIN AF of Example 37, wherein the PIN AF is a mobile network operator (MNO) PIN AF or a third-party PIN AF.

Example 39 is the PIN AF of Example 37, wherein the PIN AF creates policies specific to a PIN.

Example 40 is the PIN AF of Example 39, wherein the PIN AF provides the policies for storage in a Policy Control Function (PCF).

Example 41 is the PIN AF of Example 39, wherein the PIN policies include route selection, PIN size information (e.g., a maximum number of devices), timing and/or location restrictions, and/or an indication whether the 5GS has to be involved in the creation of the PIN.

Example 42 is the PIN AF of Example 37, wherein the PIN AF is responsible for provisioning PIN parameters to a core network of an associated wireless communication system.

Example 43 is the PIN AF of Example 42, wherein the PIN parameters include network size, throughput, and/or capacity.

Example 44 is the PIN AF of Example 37, wherein the PIN AF subscribes to receive notifications related to PINs from an associated wireless communication system.

Example 45 is the PIN AF of Example 37, wherein the PIN AF initiates PIN parameter provisioning.

Example 46 is the PIN AF of Example 45, wherein the PIN AF initiating the PIN parameter provisioning involves the PIN AF invoking an Nnef_ParameterProvision_Create message for a new PIN creation event, the Nnef_ParameterProvision_Create message sent to a Network Exposure Function (NEF).

Example 47 is the PIN AF of Example 46, wherein the PIN AF includes PIN policy parameters in the invoked message that is sent to the NEF.

Example 48 is the PIN AF of Example 37, wherein the PIN AF subscribes to PIN parameter notification.

Example 49 is the PIN AF of Example 48, wherein the PIN AF invokes a Nnef_EventExposure_Subscribe message for a new PIN creation event, the Nnef_EventExposure_Subscribe message sent to a Network Exposure Function (NEF).

Example 50 is the PIN AF of Example 49, wherein the PIN AF includes PIN characteristics in the invoked message that is sent to NEF.

Example 51 is the PIN AF of Example 37, wherein the PIN AF acts as a Data Network (DN)-authentication, authorization, accounting (AAA) entity, to perform secondary authentication and authorization.

Example 52 is the PIN AF of Example 51, wherein the PIN AF receives, from a Session Management Function (SMF), a request to authorize a new Protocol Data Unit (PDU) session.

Example 53 is the PIN AF of Example 52, wherein the PIN AF performs the secondary authentication and authorization in response to receiving the request.

Example 54 is the PIN AF of Example 37, wherein the PIN AF exchanges PIN information with a user equipment (UE) of a PIN.

Example 55 is the PIN AF of Example 54, wherein the PIN AF exchanges the PIN information using application layer signaling.

Example 56 is the PIN AF of Example 54, wherein the PIN information includes PIN policies from the UE.

Example 57 is the PIN AF of Example 37, wherein the PIN AF receives an event exposure message indicative of a PIN creation, the event exposure message including a new PIN creation event with a unique ID.

Example 58 is the PIN AF of Example 57, wherein, in response to receiving the event exposure message, the PIN AF decides on PIN policies for the created PIN; and provisions PIN policies specific to the PIN

Example 59 is the PIN AF of Example 57, wherein, in response to receiving the event exposure message, the PIN AF assigns a PIN identifier to the created PIN and/or provides PIN restrictions for the created PIN.

Example 60 includes a Session Management Function (SMF) of a core network of a wireless communication system.

Example 61 is the SMF of Example 60, wherein, the SMF is configured to: receive, from an Access & Mobility Management Function (AMF), a request for subscription information of a user equipment (UE), the subscription information indicating whether the UE has active management capability (PEMC) and and/or an active gateway capability (PEGC); and provide the subscription information to the AMF.

Example 62 is the SMF of Example 60, wherein the SMF is configured to: fetch session management (SM) policies applicable to a personal Internet-of-things (IoT) network (PIN); and route PIN traffic based on the SM policies.

Example 63 is the SMF of Example 60, wherein the SMF is configured to: receive a PDU session establishment request from a user equipment (UE); evaluate whether it is allowed to establish the PDU session at a current time and from a location of the UE; and in response to determining that it is allowed to do so, contacting a PIN Application Function for secondary authorization.

Example 64 includes a Policy Control Function of a core network of a wireless communication system.

Example 65 is the PCF of Example 64, wherein the PCF is configured with default policies for personal Internet-of-things network (PIN) configurations.

Example 66 is the PCF of Example 64, wherein the PCF receives personal Internet-of-things network (PIN) policies from a PIN Application Function (AF) and/or from a Unified Data Management (UDM).

Example 67 is the PCF of Example 66, wherein the PCF queries the UDM to retrieve one or more PIN policies applicable to a subscription of a user equipment (UE).

Example 68 is the PCF of Example 67, wherein the PCF sends instructions to an Access & Mobility Management Function (AMF) to provide the one or more PIN policies to the UE.

Example 69 is the PCF of Example 66, wherein the PCF receives a request for PIN policies from a user equipment (UE).

Example 69 is the PCF of Example 66, wherein the PCF sends a policy update to an AMF, wherein the PIN policies include a PIN identifier and/or URSP rules for PIN traffic.

Example 70 is a Unified Data Management (UDM) of a core network of a wireless communication system.

Example 71 is the UDM of Example 70, wherein the UDM stores UE subscription data, which can include a UE's authorization to act as a PEGC and/or a PEMC.

Example 72 is the UDM of Example 70, wherein the UDM stores one or more policies for PINs.

Example 73 may include one or more non-transitory computer-readable media comprising instructions to cause an electronic device, upon execution of the instructions by one or more processors of the electronic device, to perform one or more elements of a method described in or related to any of examples 1-72, or any other method or process described herein.

Example 74 may include an apparatus comprising logic, modules, or circuitry to perform one or more elements of a method described in or related to any of examples 1-72, or any other method or process described herein.

Example 75 may include a method, technique, or process as described in or related to any of examples 1-72, or portions or parts thereof.

Example 76 may include an apparatus comprising: one or more processors and one or more computer-readable media comprising instructions that, when executed by the one or more processors, cause the one or more processors to perform the method, techniques, or process as described in or related to any of examples 1-72, or portions thereof.

Example 77 may include a signal as described in or related to any of examples 1-72, or portions or parts thereof.

Example 78 may include a datagram, information element, packet, frame, segment, PDU, or message as described in or related to any of examples 1-72, or portions or parts thereof, or otherwise described in the present disclosure.

Example 79 may include a signal encoded with data as described in or related to any of examples 1-72, or portions or parts thereof, or otherwise described in the present disclosure.

Example 80 may include a signal encoded with a datagram, IE, packet, frame, segment, PDU, or message as described in or related to any of examples 1-72, or portions or parts thereof, or otherwise described in the present disclosure.

Example 81 may include an electromagnetic signal carrying computer-readable instructions, wherein execution of the computer-readable instructions by one or more processors is to cause the one or more processors to perform the method, techniques, or process as described in or related to any of examples 1-72, or portions thereof.

Example 82 may include a computer program comprising instructions, wherein execution of the program by a processing element is to cause the processing element to carry out the method, techniques, or process as described in or related to any of examples 1-72, or portions thereof.

Example 83 may include a signal in a wireless network as shown and described herein.

Example 84 may include a method of communicating in a wireless network as shown and described herein.

Example 85 may include a system for providing wireless communication as shown and described herein.

Example 86 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

Although the embodiments above have been described in considerable detail, numerous variations and modifications will become apparent to those skilled in the art once the above disclosure is fully appreciated. It is intended that the following claims be interpreted to embrace all such variations and modifications.

1-21. (canceled)

22. An apparatus in a wireless communication network, the apparatus comprising:
processing circuitry configured to perform operations comprising:
instructing communication circuitry to receive, from the wireless communication network, user equipment (UE) route selection policy (URSP) rules for traffic of a personal Internet-of-things network (PIN), the URSP rules comprising an identifier of the PIN (PIN ID);
instructing the communication circuitry to receive PIN traffic from at least one PIN device; and
determining, based on the URSP rules, a Protocol Data Unit (PDU) session for the PIN traffic.

23. The apparatus of claim 22, wherein determining, based on the URSP rules, a Protocol Data Unit (PDU) session for the PIN traffic comprises:
evaluating the URSP rules; and
based on the evaluation, instructing the communication circuitry to transmit a PDU session establishment request to the wireless communication network.

24. The apparatus of claim 23, the operations further comprising:
based on the evaluation, selecting a Data Network Name (DNN) and a serving network slice selection assistant information (S-NSSAI) combination for the PDU session.

25. The apparatus of claim 24, wherein the PDU session is established to a specific DNN and associated with a network slice identified by the S-NSSAI.

26. The apparatus of claim 23, the operations further comprising:
instructing the communication circuitry to receive a PDU session establishment acceptance from the wireless communication network; and
in response to receiving the PDU session establishment acceptance, associating the PIN with the PDU session.

27. The apparatus of claim 22, wherein determining, based on the URSP rules, a Protocol Data Unit (PDU) session for the PIN traffic comprises:
selecting an existing PDU session for the PIN traffic.

28. The apparatus of claim 22, wherein the apparatus is a UE, and wherein the UE is a gateway for the PIN to the wireless communication network.

29. The apparatus of claim 22, wherein the apparatus is a baseband processor.

30. The apparatus of claim 22, wherein the wireless communication network is a 5th Generation (5G) network, and the operations further comprising:
generating a registration request to register with the 5G network; and
instructing communication circuitry to transmit the registration request to the 5G network.

31. The apparatus of claim 30, wherein the registration request comprises a policy container.

32. The apparatus of claim 22, the operations further comprising:
routing the PIN traffic on the PDU Session.

33. The apparatus of claim 22, wherein the PIN ID is generated by a PIN application function (AF).

34. One or more processors configured to perform operations comprising:
receiving, by a Policy Control Function (PCF), a notification indicating receipt of parameters for a personal Internet-of-things network (PIN);
responsively generating, by the PCF and based on the PIN parameters, user equipment (UE) route selection policy (URSP) rules for the PIN, the URSP rules comprising an identifier for the PIN (PIN ID); and
provisioning, by the PCF, the URSP rules to a user equipment (UE) registered as a gateway for the PIN.

35. The one or more processors of claim 34, the operations further comprising:
receiving, via a Network Exposure Function (NEF) and from a PIN application function (AF), the PIN parameters for the PIN including the PIN ID.

36. The one or more processors of claim 34, the operations further comprising: storing the PIN parameters in a User Data Repository.

37. The one or more processors of claim 34, wherein the PIN parameters comprises at least one of route selection information or location restrictions.

38. A user equipment (UE) comprising:
one or more processors; and
memory storing instructions that when executed by the one or more processors, cause the UE to perform operations comprising:
generating a registration request comprising a capability of the UE to serve as a gateway for a personal Internet-of-things network (PIN) to a wireless communication network;
sending the registration request to the wireless communication network; and
receiving, from the wireless communication network, a registration accept message comprising a PIN gateway authorization.

39. The UE of claim 38, wherein the registration request further comprises at least one of: a PIN identifier, a PIN class, a PIN traffic scope providing a location of PIN traffic, a PIN traffic class, or a PIN size.

40. The UE of claim 38, the operations further comprising:
receiving, from the wireless communication network, one or more sets of UE route selection policy (URSP) rules for PIN traffic, each the set of URSP rules comprising a PIN identifier (PIN ID) of the PIN.

41. The UE of claim 38, the operations further comprising:
receiving application traffic from at least one other device in the PIN;
determining a first set of URSP rules for the application traffic; and
based on the first set of URSP rules, selecting a Protocol Data Unit (PDU) session for the application traffic.
